(19) United States
(12) Patent Application Publication
(10) Pub. No.: US 2025/0215260 A1
(43) Pub. Date: Jul. 3, 2025

(54) SILPHENYLENE POLYMERS

(71) Applicant: WACKER CHEMIE AG, München (DE)

(72) Inventors: Frank Sandmeyer, Burgkirchen (DE); Sebastian Knör, Emmerting (DE); Vanessa Koch, München (DE)

(73) Assignee: Wacker Chemie AG, Munich (DE)

(21) Appl. No.: 18/852,526

(22) PCT Filed: May 17, 2022
(86) PCT No.: PCT/EP2022/063332

§ 371 Date: Sep. 30, 2024

(51) Int. Cl. C09D 183/14; C08G 77/52

(52) U.S. Cl. CPC C09D 183/14; C08G 77/52

(57) ABSTRACT

Silphenylene polymers along with processes for producing and uses for the same. Where the Silphenylene polymers have the formula (I)

RₐR¹_{b}Si[Y[(SiR²_{c}R³_{d})ₑ]_{f}]_{g}YSiRₐR¹_{b} (I).

At least one olefinically or acetylenically unsaturated radical R, R¹, R² or R³ must be present per silphenylene polymer of the formula (I). Where the sum of all organic radicals bonded to Si atoms through an oxygen atom, based on the sum of all Si-bonded radicals R, R¹, R² and R³ as 100 mol %, must not be more than 10 mol %. Where based on all bridging radicals Y as 100 mol %, at least 55 mol % of radicals Y are a di- to dodecavalent aromatic, alkylaromatic and cycloalkylaromatic radical.

The present invention relates to radically curable silphenylene polymers, to a process for preparing them, and to their use as binders in radiofrequency applications.

### PRIOR ART

Accompanying the progress in the opening-up of radiofrequency technology for wireless communication is a rise in demand for materials capable of realizing this technology. This relates to all sectors of materials such as copper foils, binders, glass fibers, etc. In the case of the binders, the epoxy resins used conventionally for producing copper-faced laminates and subsequently for circuit board production can no longer be employed, because their dielectric loss factors are too high. Polytetrafluoroethylene, which possesses a very low dielectric loss factor and on that basis is very useful for radiofrequency applications, carries other disadvantages, particularly the poor workability and poor adhesion properties, and these make an alternative desirable. Polyphenylene ethers are presently being utilized intensively as binders for this area of application, as they combine low dielectric loss factors with good mechanical and thermal properties and water repellency. Presently, in addition, other organic polymers as well are being considered in the current development activities for this field of application, examples being bismaleimide polymers, bismaleimide-triazine copolymers and hydrocarbon resins, in a listing which could be supplemented with further examples.

Polyorganosiloxanes possess fundamentally excellent heat resistance, weathering stability and hydrophobicity, are flame-retardant, and possess low dielectric loss factors.

These profiles of properties qualify not only the stated organic polymers but also the polyorganosiloxanes for use as binders for the production of radiofrequency-compatible, copper-faced laminates and components, such as circuit boards and antennas. It is therefore obvious to utilize the positive properties of these classes of materials for modern-day radiofrequency applications, and they can in each case be used either alone or else in combination with one another, to achieve a symbiotic increase in their performance capacity. Experiments in this direction have already been documented in the prior art.

Polar substituents here are undesirable, as they push up the dielectric loss factor. In this context, polyorganosiloxanes possess an inherent disadvantage over the other organic binders, since their framework is constructed of silicon atoms and oxygen atoms, generally in alternation. The difference in electronegativity between silicon and oxygen, according to the electronegativity scale of Allred and Rochow, is 3.50−1.74=1.76. Here, the electronegativity for silicon is 1.74, and 3.5 is the electronegativity for oxygen. Conversely, the electronegativity difference between carbon and oxygen is only 3.5−2.5=1.0, with 2.5 being the electronegativity for carbon. It is known that differences in electronegativity can be sterically shielded and not manifest themselves externally, as in the case, for instance, of polytetrafluoroethylene, which in spite of an electronegativity difference between carbon and fluorine of 1.67 exhibits excellent dielectric properties. A similar shielding effect could be assumed for symmetrical polydiorganosiloxanes, examples being polydimethylsiloxanes. In contrast to polytetrafluoroethylene, however, polydimethylsiloxanes do not possess suitable working properties for use as binders for radiofrequency applications. With polydiorganosiloxanes, for example, the production of prepregs and their subsequent curing are not possible and the viscosities attained are not sufficiently high, preventing the polydiorganosiloxanes from running away under the effect of the heat from molten tin as part of a soldering procedure. Even through crosslinking, such as the radical polymerization of the binders used that is employed preferably for the production of metal-faced laminates, for example, it is not possible for polydiorganosiloxanes to attain sufficient mechanical strength under heat exposure. Rather than highly crosslinked elements which are dimensionally stable even under temperature load, as this application requires, the crosslinking of polyorganosiloxanes under the influence of heat may produce polymers which are reversibly deformable, i.e., elastomeric. Moreover, polydiorganosiloxanes are incompatible with organic polymers, thus considerably limiting−if not, indeed, ruling out−the possibilities for formulating suitable binder mixtures.

Candidate binders for radiofrequency applications include polyorganosiloxanes which possess a three-dimensional framework structure and which, furthermore, can be crosslinked chemically to form thermosets. Corresponding examples are known in the patent literature: see, for instance, US 2016/0244610 (compositions of mixtures of olefinically unsaturated MQ resins with polyphenylene ethers modified for unsaturation), US 2018/0220530 (compositions of mixtures of polyphenylene ethers with MT, MDT, MDQ and MTQ silicone resins) or US 2018/0215971 (compositions of mixtures of polyphenylene ethers with TT and TQ silicone resins).

The target dielectric loss factors in these inventions are <0.007. Freshly produced specimens of the materials described therein meet this requirement, although do not go significantly below it, and so this prior art leaves considerable room for improvement, as the materials are significantly distant from the dielectric properties of polytetrafluorethylenes, which achieve dielectric loss factors in the region of 0.0001. Since complete shielding of the polarities of the Si—O—Si framework units in polyorganosiloxanes having a three-dimensional framework structure is not possible, this structural element becomes an inherent disadvantage of polyorganosiloxanes and will always be a barrier to them achieving lower dielectric loss factors.

Attempts to replace parts of the polyorganosiloxane framework with other bridging units, rather than with Si—O—Si units, are documented in U.S. Pat. No. 3,395,168, for example. Common to these inventions, however, is that significant portions of the polyorganosiloxane framework are nevertheless retained.

U.S. Pat. No. 6,072,016 teaches linear, condensation-crosslinking silphenylene polymers as part of a condensation-curing silicone preparation. The linear, condensation-crosslinking silphenylene polymers described therein, themselves, are condensable as a result of hydrolyzable end groups. It is possible in principle for these linear, condensation-crosslinking silphenylene polymers to be free of Si—O—Si units; however, their curing, as intended, produces polyorganosiloxanes, in which some of the linkages between adjacent silicon atoms are different from Si—O—Si units, with the units bridging the Si atoms being present in Si—C-bonded form. As well as silphenylene units, the silphenylene polymers also contain silalkylene units, this being an unavoidable side-effect of their preparation by hydrosilylation reactions of silphenylene units with olefinically unsaturated termination. Pure polysilphenylenes are not available in this way and are also not taught in U.S. Pat. No. 6,072,016. It should also be noted that the starting materials for the hydrosilylation in U.S. Pat. No. 6,072,016 are accessible only through metal-mediated coupling reactions, such as the Grignard reaction or a Wurtz coupling, for instance. These synthesis methods, while they can be implemented on an industrial scale, are nevertheless challenging, and so the overall cost and complexity of realizing this technology are so considerable that the inevitable assumption is that a lack of profitability will doom this technology or allow it to break through only in markets where prices are extremely high and volumes, accordingly, very low. As for the dielectric properties, the likelihood is that, because of platinum residues in the product from the hydrosilylation, increased dielectric loss factors can be expected, meaning that a further step would be needed in order to make the technology—which is already costly and inconvenient in any case—capable of being utilized for radiofrequency applications. In other words, the state of the art according to U.S. Pat. No. 6,072,016 would first have to be developed further in order to be able to be employed industrially in the target application of the present invention, apart from the additional economic disadvantages which it throws up.

U.S. Pat. No. 10,982,053 describes polymers comprising linear aliphatic polyethers modified with silphenylene units. The polymers described there can carry phenol or epoxide groups. The copolymers described there are obtained by hydrosilylation of olefinically unsaturated polyethers with Si-H-functional silphenylene units. According to the teaching of U.S. Pat. No. 10,982,053, pure silphenylene polymers are not obtainable. The essential structural unit of the polymers according to U.S. Pat. No. 10,982,053 is the polyether unit.

US 2011/0275768 imparts a teaching similar to that of U.S. Pat. No. 10,982,053, where the organic units located between the individual silphenylene units differ from the polyether units according to U.S. Pat. No. 10,982,053. In the case of US 2011/0275768 as well, organosilicon polymers composed exclusively or predominantly of silphenylene units are not covered by the subject matter of the teaching described therein.

EP 0913420 teaches silphenylene silalene polymers of alternating construction, which are obtained by hydrosilylation reactions of olefinically unsaturated silphenylene units with Si—H-terminal silphenylene units, similarly to U.S. Pat. No. 6,072,016. The profitability is subject to the same statements as already set out for U.S. Pat. No. 6,072,016. Here as well, costly and complicated, metal-mediated coupling reactions are required in order to produce the starting materials needed. Only then can the hydrosilylation take place, and is itself an expensive synthesis in turn, owing to the platinum catalyst used. The platinum remains in the product and increases the dielectric loss factor. Platinum would have first to be removed in order for dielectric properties with radiofrequency compatibility to be achieved. That would require a further step and an improvement to the prior art of EP 0913420, that went beyond the teaching of EP 0913420.

In the copolymers according to EP 0913420, as already suggested by the fact that the polymers are designated as silphenylene silalkylene polymers, there is a regular alternation of phenylene and alkylene bridging. This is inevitable given that the vinyl groups needed for polymer synthesis, which through hydrosilylation with Si—H units become bridging alkanediyl units, regularly alternate with the phenylene units in the completed polymer framework. The phenylene units that bridge Si atoms are in turn, as described above, obtainable only through metal-mediated coupling reactions, whether these be the Grignard reaction or a coupling in the manner of a Wurtz reaction. In the silphenylene-silalkylene copolymers according to EP 0913420, therefore, 50% of the bridging radicals which bridge adjacent Si atoms are arylene radicals and 50% are alkylene radicals, or alkanediyl radicals. Since the starting units employed have exclusively twofold symmetrical functionalization, high molecular mass linear polymers are obtained which are terminated with the remaining Si—H and/or the olefinic groups. Here, instead of silphenylene units with twofold olefinic unsaturation, it is also possible to use purely organic starting units with twofold hydrosilylatability, such as diolefins or acetylenes. The silphenylene silalkylene polymers described therein have sufficient solubility to be able to be used in the target application, as coating materials, only if there is a minimum fraction of 20 mol % of silicon-bonded phenyl substituents present. Silphenylene polymers with random construction neither are described in EP 0913420 nor are available through the processes described in EP 0913420. The spectrum of the structural chemistry which is accessible in accordance with this prior art is therefore highly limited. General access to any desired silphenylene polymers is therefore not taught by EP 0913420. The accompanying use of aliphatic units in the silphenylene-silalkylene copolymers according to EP 0913420 is unavoidable. It is known that the thermal stabilities attained with aliphatic, silicon-bonded units are lower than those obtained with aromatic, silicon-bonded radicals. If the silalkylene units in the silphenylene-silalkylene copolymers of EP 0913420 are replaced by siloxane units, it is possible to realize high thermal stabilities, as described in part in the prior art already cited. Since, however, this gives rise to disadvantages in terms of the dielectric properties which can be achieved, the known prior art always produces either a reduced thermal stability or a reduced performance capacity in terms of the dielectric properties. The combination of high thermal robustness, as anticipated for pure silphenylene polymers, and the optimal electrical insulation properties, obtainable in an economic process, cannot yet be derived from the existing prior art. This is the object addressed by the present invention.

U.S. Pat. No. 9,751,989 teaches condensation-crosslinkable polyorganosiloxanes having oligosilphenylene units for use as material for encapsulating LEDs. US 2017/051114 teaches hydrosilylation-curing preparations comprising Si—H-terminated oligosilphenylenes and alkenyl-functional polyorganosiloxanes. In both cases, in the case of as-intended use, the end products are polyorganosiloxanes which contain both polyorganosiloxane units and oligosilphenylene units. Olefinically unsaturated, radically curable silphenylene polymers are not part of the teaching of these two specifications.

### OBJECT AND SUBJECT OF THE INVENTION

The object was to provide polymers crosslinkable by a radical polymerization which combine the advantageous properties of three-dimensionally crosslinkable polyorganosiloxanes, such as excellent heat resistance, weathering stability, water repellency and flame retardance, with improved dielectric properties, more particularly lower dielectric loss factors, and which are suitable for use as binders for metal-faced laminates for electronic applications and are accessible economically. Part of this is that in the form of pure binder at 10 GHz they possess a dielectric loss factor of not more than 0.0030, effectively wet any fillers present that lower the dielectric loss factor, allow the production of tack-free prepregs, produce preparations that are compatible with organic polymers, are amenable to curing under the effect of heat to give dimensionally stable moldings, and have good solubility in the typical application solvents. The object is achieved by the invention.

A subject of the invention are silphenylene polymers of the formula (I)

RₐR¹_{b}Si[Y[(SiR²_{c}R³_{d})ₑ]_{f}]_{g}YSiRₐR¹_{b} (I).

where
R may be identical or different radicals and are a hydrogen radical or an olefinically or acetylenically unsaturated, aliphatic or cycloaliphatic hydrocarbon radical,
R² independently of one another are identical or different radicals, where R² may be a hydrogen radical or a saturated or olefinically or acetylenically unsaturated, Si—C-bonded C₁-C₁₈ hydrocarbon radical which may be substituted by heteroatoms, with oxygen atoms and silicon atoms being preferred as heteroatoms, where the two or more oxygen atoms in the same radical R² are always separated from one another by hydrocarbon units and where oxygen atoms and silicon atoms are not joined to one another to form Si—O units if both kinds of heteroatom are present simultaneously in one radical R², but instead are always separated from one another by hydrocarbon units, whereas two or more Si atoms in the same radical R² may be joined to one another by direct Si—Si bonds and the Si atoms are always tetravalent and the remaining valences of the Si atoms are saturated by further Si—C-bonded substituents, preferably C₁-C₁₂ alkyl, cycloalkyl or aryl radicals, it being possible for these to be olefinically or acetylenically unsaturated,
and R² may also comprise olefinically or acetylenically unsaturated functional groups, which may likewise contain heteroatoms, where R² may also be a hydroxyl radical or a monovalent aliphatic, cycloaliphatic or aromatic, Si—C-bonded, organic hydrocarbon radical which is bonded to the silicon atom through an oxygen atom, is unsubstituted or substituted by heteroatoms and has 1 to 18 carbon atoms.

The radical R² may in particular also be a radical of the formula (II) [Y[(SiR^{b}_{c}R³_{d})ₑ]_{f}]_{g}YSiRₐR¹_{b}, where Y, R, R¹, R², R³, a, b, c, d, e, f and g have the definitions indicated in the text.

R¹ and R³ may independently of one another be identical or different radicals and are either a hydrogen radical or a monovalent aliphatic, cycloaliphatic or aromatic, Si—C-bonded, organic hydrocarbon radical which is unsubstituted or substituted by heteroatoms and has 1 to 18 carbon atoms, and which may also be an unsaturated hydrocarbon radical, where R¹ and R³ may also be a hydroxyl radical or a monovalent aliphatic, cycloaliphatic or aromatic, Si—C-bonded, organic hydrocarbon radical which is bonded to the silicon atom through an oxygen atom, is unsubstituted or substituted by heteroatoms and has 1 to 18 carbon atoms.

It is a condition of the invention that there must always be at least one olefinically or acetylenically unsaturated radical R, R¹, R² or R³ per silphenylene polymer of the formula (I). There are preferably at least two such olefinically or acetylenically unsaturated radicals R, R¹, R² or R³ per silphenylene polymer of the formula (I). The olefinically or acetylenically unsaturated radicals R and R¹ here are always bonded terminally; the olefinically or acetylenically unsaturated radicals R² and R³ are always bonded to Si atoms which lie in the interior of the polymer framework (i.e., internally). There is no particular restriction on whether the olefinically or acetylenically unsaturated groups are present terminally or internally. Both are possible, optionally also as a hybrid form. It is a condition of the invention, however, that the preferably at least 2 olefinically or acetylenically unsaturated groups are present on different Si atoms and are not bonded on the same Si atom.

With regard to the number of the oxygen-bonded radicals R, R¹, R² and R³, it should be borne in mind that the sum of all organic radicals bonded to Si atoms through an oxygen atom, based on the sum of all Si-bonded radicals R, R¹, R² and R³ as 100 mol %, may not be more than 10 mol %, more preferably not more than 8 mol %, more particularly not more than 5 mol %, especially preferably less than 1 mol %. Consideration should be given here to the fact that radicals bonded through oxygen atoms to Si atoms are not desired in the silphenylene polymers of the formula (I) of the invention. They do not contribute to improved performance capacity of the silphenylene polymers of the invention, but instead, on the contrary, bring about a reduced performance capacity. It is therefore most preferable for there to be no radicals bonded to Si atoms through oxygen atoms in the silphenylene polymers of the invention. However, the formation of such radicals cannot always be suppressed entirely, owing to secondary reactions during the synthesis. Limited amounts, therefore, are permitted as in accordance with the invention, although are not preferred. The best performance capacity is achieved with complete avoidance of any Si—O bonds in the silphenylene polymers of the invention.

The silphenylene polymers of the invention contain preferably less than 10 mol % of Si—O-linked structural groups, more preferably less than 8 mol % of Si—O-linked structural groups, more particularly less than 5% of Si—O-linked structural groups, especially preferably less than 1% of Si—O-linked structural groups. By Si—O-linked structural groups here are meant not only Si—O—Si framework units but also Si—O units in which the oxygen atom is bonded to a silicon atom on one side only and the second oxygen-bonded radical is not bonded through a silicon atom to the oxygen. It is preferred more particularly for the silphenylene polymers of the invention to be free from Si—O—Si units. The silphenylene polymers of the invention may be blended with polyorganosiloxanes and/or polysiloxane-polysilphenylene copolymers and/or organic polymers and may optionally be used together with them if such use is advantageous for the selected application. Such mixtures, and also those containing the silphenylene polymers of the invention plus organic polymers, additives, fillers, pigments, etc., are likewise in accordance with the invention.

Y is a chemical bond or a di- to dodecavalent aromatic, alkylaromatic or cycloalkylaromatic or a di- to dodecavalent aliphatic or cycloaliphatic radical having 1 to 48 carbon atoms and a main chain of which is free from heteroatoms, so that the main chain, therefore, does not for example have an ether or polyether structure, such structure instead being possibly present optionally only as a pendant radical bonded to the main chain, where Y may also contain olefinically or acetylenically unsaturated functional groups which apart from carbon atoms may also comprise heteroatoms, such as N, P, O and S atoms, where oxygen atoms are particularly preferred as heteroatoms in the functional groups, with the presence of two or more oxygen atoms bonded directly to one another being excluded.

The radical Y, if it is not a chemical bond, is always bonded by Si—C linkage to the silicon atoms that it bridges. Y is preferably a di- to dodecavalent aromatic, alkylaromatic, cycloalkylaromatic radical. It is a condition of the invention that there is always a greater number of such di- to dodecavalent aromatic, alkylaromatic and cycloalkylaromatic radicals than di- to dodecavalent aliphatic or cycloaliphatic radicals and that the di- to dodecavalent aliphatic or cycloaliphatic radicals alternate randomly with the di- to dodecavalent aromatic, alkylaromatic, cycloalkylaromatic radicals and not in a regular sequence. This also means that the di- to dodecavalent aromatic, alkylaromatic, cycloalkylaromatic radicals and the di- to dodecavalent aliphatic or cycloaliphatic radicals may be present in blocks, composed in each case of a greater number of di- to dodecavalent aromatic, alkylaromatic, cycloalkylaromatic radicals or di- to dodecavalent aliphatic or cycloaliphatic radicals, respectively.

A further condition imposed on the silphenylene polymers of the invention is that there is always a greater number of radicals Y which are a di- to dodecavalent aromatic, alkylaromatic and cycloalkylaromatic radical than radicals Y which are a chemical bond. Based on all bridging radicals Y as 100 mol %, at least 55 mol % are radicals Y which are a di- to dodecavalent aromatic, alkylaromatic and cycloalkylaromatic radical, preferably at least 60 mol %, more preferably at least 70 mol %, more particularly at least 80 mol %. In one particularly preferred form of the invention, all radicals Y are those which are a di- to dodecavalent aromatic, alkylaromatic and cycloalkylaromatic radical.

The silphenylene polymers of the invention have an arbitrary composition, i.e. a random composition. The condition of the random composition is achieved automatically by the synthesis process employed, through which the formation of silphenylene polymers with regularly alternating aromatic units contained radicals Y with aliphatic or cycloaliphatic radicals Y not favored.

Two or more radicals Y may have their definition independently of one another, and so two or more radicals Y may be different radicals, within the ambit of the definitions indicated, in a silphenylene polymer of the formula (I).

The definition of the indices is as follows:
a is a number with a value of 1 or 2, preferably 1.
b is a number with a value of 1 or 2, preferably 2, where the sum a+b=3.
c is a number with a value of 0, 1 or 2.
d is a number with a value of 0, 1 or 2, where the sum c+d=2.
e is a number from 1 to 12, preferably from 1 to 6, more preferably 1 to 3, more particularly 1. If e in [(SiR²_{c}(R³_{d})ₑ] is a number greater than 1, then two or more units of the formula (SiR²_{c}(R³_{d}) are bonded to one another via Si—Si bonds, to produce disilane units, trisilane units, etc., up to polysilane units, according to the value of e.
f is a number with a value of 1 to 12, more particularly 1.
g is a number with a value of 3 to 250, more preferably of 4 to 150, more particularly of 5 to 50.

Examples of radicals R apart from the hydrogen atoms are alkenyl radicals, such as the 7-octenyl, 5-hexenyl, 3-butenyl, allyl and the vinyl radical. Additionally included acryloyloxy or methacryloyloxy radicals from acrylic acid or methacrylic acid, and also the acrylic esters or methacrylic esters of unbranched or branched alcohols having 1 to 15 carbon atoms. Preferred such radicals are those which derive from methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, tert-butyl acrylate, tert-butyl methacrylate, 2-ethylhexyl acrylate and norbonyl acrylate. Particularly preferred are methyl acrylate, methyl methacrylate, n-butyl acrylate, isobutyl acrylate, tert-butyl acrylate, 2-ethylhexyl acrylate and norbonyl acrylate. These radicals are preferably not bonded directly to the silicon atom, but are instead bonded via a hydrocarbon spacer which may comprise 1 to 12 carbon atoms, and preferably comprises 1 or 3 carbon atoms and comprises no heteroatoms other than the heteroatoms present in the acryloyloxy and/or methacryloyloxy radical.

Examples of radicals R¹, R² and R³ apart from the hydrogen atom are saturated or unsaturated hydrocarbon radicals, which may contain aromatic or aliphatic double bonds, e.g., alkyl radicals, such as the methyl, ethyl, n-propyl, isopropyl, n-butyl, isobutyl, tert-butyl, n-pentyl, isopentyl, neopentyl and the tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl and the 2-ethylhexyl radical, nonyl radicals, such as the n-nonyl radical, decyl radicals, such as the n-decyl radical, dodecyl radicals, such as the n-dodecyl radical, tetradecyl radicals, such as the n-tetradecyl radical, hexadecyl radicals, such as the n-hexadecyl radical, and octadecyl radicals, such as the n-octadecyl radical, cycloalkyl radicals, such as cyclopentyl, cyclohexyl and 4-ethylcyclohexyl radical, cycloheptyl radicals, norbornyl radicals and methylcyclohexyl radicals, aryl radicals, such as the phenyl, biphenyl, naphthyl and anthryl and phenanthryl radical; alkaryl radicals, such as o-, m- and p-tolyl radicals, xylyl radicals and ethylphenyl radicals; aralkyl radicals, such as the benzyl radical, alkenyl radicals, such as the 7-octenyl, 5-hexenyl, 3-butenyl, allyl and the vinyl radical, and also the alpha- and the β-phenylethyl radical.

Preferred heteroatoms which may be present in the radicals R¹, R² and R³ are oxygen atoms.

Furthermore, nitrogen atoms, phosphorus atoms, sulfur atoms and halogen atoms such as chlorine atoms and fluorine atoms are also possible, but not preferred.

Examples of preferred heteroatom-containing organic radicals R¹, R² and R³ are the acryloyloxy and methacryloyloxy radicals from acrylic acid or methacrylic acid, respectively, and also the acrylic esters or methacrylic esters of unbranched or branched alcohols having 1 to 15 carbon atoms. Preferred such radicals are those which derive from methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, tert-butyl acrylate, tert-butyl methacrylate, 2-ethylhexyl acrylate and norbornyl acrylate. Particularly preferred are methyl acrylate, methyl methacrylate, n-butyl acrylate, isobutyl acrylate, tert-butyl acrylate, 2-ethylhexyl acrylate and norbornyl acrylate.

These radicals are preferably not bonded directly to the silicon atom, but are instead bonded via a hydrocarbon spacer which may comprise 1 to 12 carbon atoms, which preferably comprises 1 or 3 carbon atoms and comprises no heteroatoms other than the heteroatoms included in the acryloyloxy and/or methacryloyloxy radical.

The radicals R¹, R² and R³ are preferably selected from methyl, phenyl, vinyl, acryloyloxy and methacryloyloxy radicals and also the acrylic esters or methacrylic esters of unbranched or branched alcohols having 1 to 15 carbon atoms.

Further preferred heteroatom-comprising radicals R¹, R² and R³ are those of the formula (III).

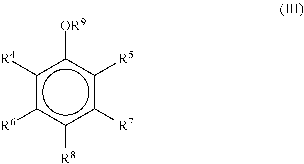

In formula (III), R⁴, R⁵, R⁶, R⁷, R⁸ and R⁹ independently of one another are a hydrogen radical, a hydrocarbon group or a hydrocarbon group substituted by extraneous atoms, where always at least one of the radicals R⁴, R⁵, R⁶, R⁷, R⁸ and R⁹ is a hydrocarbon group which is bonded via an Si—C bond to the silicon atom, where this hydrocarbon group via which the radical of the formula (III) is bonded to a silicon atom is preferably a C3 hydrocarbon group containing no heteroatoms. Alternatively, the radical R⁴, R⁵, R⁶, R⁷, R⁸ and R⁹ may also be a chemical bond, so that the radical of the formula (III) is bonded directly to the silicon atom via an Si—C bond to the aromatic ring.

Examples of radicals R⁴, R⁵, R⁶, R⁷, R⁸ and R⁹ are the hydrogen radical, saturated hydrocarbon radicals such as the methyl, ethyl, n-propyl, isopropyl, the primary, secondary and tertiary butyl radical, the hydroxyethyl radical, aromatic radicals such as the phenylethyl radical, the phenyl radical, the benzyl radical, the methylphenyl radical, the dimethylphenyl radical, the ethylphenyl radical, heteroatom-containing radicals such as the hydroxymethyl radical, the carboxyethyl radical, the methoxycarbonyl ethyl radical and the cyanoethyl radical, and acrylate and methacrylate radicals, such as methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, tert-butyl acrylate, tert-butyl methacrylate, 2-ethylhexyl acrylate and norbonyl acrylate, and olefinically or acetylenically unsaturated hydrocarbon radicals.

The adjacent radicals R⁴ and R⁶ and also the adjacent radicals R⁵ and R⁷ may optionally also be joined to one another to form the corresponding cyclic saturated or unsaturated radical, producing fused polycyclic structures.

Examples of phenol radicals of the formula (III) the phenol radical, the ortho- meta- or para-cresol radical, 2,6-, 2,5-, 2,4- or 3,5-dimethylphenol radical, 2-methyl-6-phenylphenol radical, 2,6-diphenylphenol radical, 2,6-diethylphenol radical, 2-methyl-6-ethylphenol radical, 2,3,5-, 2,3,6- or 2,4,6-trimethylphenol radical, 3-methyl-6-tert-butylphenyl radical, thymol radical and 2-methyl-6-allylphenol radical, which may optionally be substituted on the oxygen atom.

Preferred examples of fluorine-containing radicals are the trifluoropropyl, the nonafluorohexyl and the heptadecafluorooctyl radical.

Y is preferably a bridging organic, preferably aromatic unit having 1 to 24 carbon atoms between two to twelve carbosilyl units. Y is preferably di-, tri- or tetravalent, more particularly divalent.

Preferred bridging aromatic radicals Y are those of the formulae (IVa), (IVb) and (IVc)

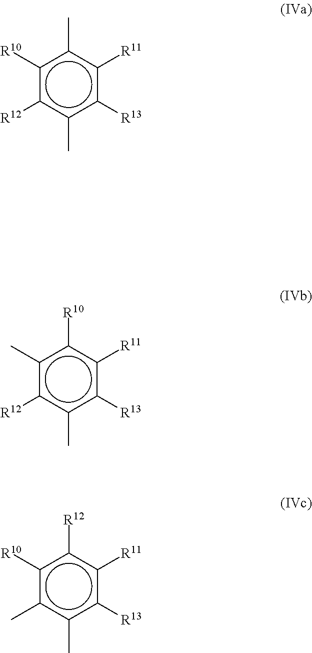

where the radicals R¹⁰, R¹¹, R¹² and R¹³ may be a hydrogen radical or are an optionally substituted hydrocarbon radical or a group of the formula OR¹⁴ where R¹⁴ is a hydrocarbon radical. Here, adjacent radicals such as R¹⁰ and R¹² or R¹¹ and R¹³ in formula (IVa), for example, may be coupled to one another to form cyclic radicals, producing fused ring systems. Similar comments apply in respect of the adjacent radicals in the formulae (IVb) and (IVc).

Typical examples of such bridging aromatic radicals are the p-, m- or o-phenylene radical, the 2-methyl-1,4-phenylene radical, the 2-methoxy-1,4-phenylene radical, with the p-phenylene radical being particularly preferred.

Optionally, it is also possible for two or more such radicals to be coupled to one another, so that, for example, two or more units of the formulae (IVa), (IVb) and (IVc) are coupled to one another and this oligomeric bridging structural element is present through attachment of the corresponding carbon atoms of the terminal aromatic rings to silicon atoms. Hybrid forms are also conceivable here, in other words oligomeric bridging units which consist not only of units of a kind of the formulae (IVa), (IVb) or (IVc) but instead of two or more, i.e., two or three, different kinds of repeating units conforming to the formulae (IVa), (IVb) and (IVc). The aromatic units in this case may be bonded directly to one another or they may be coupled to one another through a bridging group such as an alkanediyl unit, such as, for example, the methylene group, the 1,2-ethanediyl group, 1,1-ethanediyl group, the 2,2-dimethylpropyl group or a sulfone group.

Further examples of aromatic bridging units which may also contain heteroatoms are those in which two optionally substituted phenol rings are bridged via an alkane diyl or other unit. Typical representatives are—with substitution on the phenol oxygen—2,2-bis(4-hydroxyphenyl)propane radicals (substituted bisphenol A radicals), 2,2-bis(4-hydroxyphenyl)methane radicals (substituted bisphenol F radicals), bis(4-hydroxyphenyl)sulfone radicals (bisphenol S radicals), where the phenol oxygen atoms are typically substituted by radicals of the —(C₃H₆)— kind, where the —(C₃H₆)— radicals are Si—C-bonded to silicon atoms, so producing the bridging.

Preferred radicals Y not bridged by an aromatic unit are, apart from the chemical bond, alkane diyl, alkene diyl and alkyne diyl radicals, which may optionally contain heteroatoms and may contain the aromatic groups as substituents, but do not take on or contribute to the bridging function in these radicals.

Typical examples are the methylene radical, the methine radical, the tetravalent carbon, the 1,1-ethanediyl and the 1,2-ethanediyl group, the 1,4-butanediyl and the 1,3-butanediyl group, the 1,5-pentanediyl, 1,6-hexanediyl, 1,7-heptanediyl, 1,8-octanediyl, 1,9-nonanediyl, 1,10-decanediyl 1,11-undecanediyl and the 1,12-dodecanediyl group, the 1,2-diphenylethanediyl group, the 1,2-phenylethanediyl group, the 1,2-cyclohexylethanediyl group. Where a linear bridging unit possesses more than one carbon atom and where the substitution pattern allows it, each of these groups may also exert its bridging effect not only through the alpha-omega connectivity, in other words by the bridging through the respective first and last atoms of a linear unit, but also through any other connectivity, in other words the use of other chain carbon atoms. Moreover, typical examples are not only the linear representatives of the stated bridging hydrocarbons, but also their isomers, which may in turn exert their bridging effect through attachment of different carbon atoms of the hydrocarbon structure to silicon atoms.

Examples of especially preferred radicals from the group of the nonaromatic, heteroatom-free hydrocarbon radicals are —CH₂CH₂—, —CH(CH₂)—, —CH═CH—, —C(═CH₂)— and —C≡C—.

Examples of typical fluorine-substituted bridging radicals Y are the —C(CF₃)₂—, the —C(H)F—C(H)F— and the —C(F₂)—C(F₂)— radical.

Examples of typical heteroatom-containing, nonaromatic bridging radicals are, for example, divalent hydrocarbon radicals which contain secondary or tertiary alcohol functions, keto and carboxylic acid and ester functions or have pendant ether chains. Pendant here means that the respective radical has its origin in a carbon atom of the radical Y, but the end of the radical is not bonded to an Si atom which is bonded via a bridging radical to further Si atoms. As a result, this radical makes no contribution to a network structure.

All recitations are only to be understood as illustrative and nonlimiting.

As explained later on, the preferred process for preparing the silphenylene polymers of the invention lies in the application of a synthesis in the manner of a Grignard reaction. Radicals recited here as examples but not inert toward magnesium would not be tolerated, and correspondingly converted, in such a reaction. To nevertheless obtain them in the silphenylene polymers of the invention, the radicals employed in the Grignard reaction are initially only those that are inert toward magnesium, which in subsequent reactions, in accordance with known prior art, are generated in the precursors obtained from the Grignard reactions. Examples of such radicals are radicals containing carbonyl groups such as acryl- or methacryloyloxy radicals. The silphenylene polymers of the invention, depending on the average number of structural units forming them per molecule, may vary in their viscosity over a wide range or else may be solids.

Liquid silphenylene polymers of the invention in the noncrosslinked state at 25° C. possess viscosities of 20 to 8 000 000 mPas, preferably of 200 to 5 000 000 mPas, more particularly of 250 to 3 000 000 mPas.

Solid silphenylene polymers of the invention in the noncrosslinked state possess glass transition temperatures in the range from 25° C. to 250° C., preferably from 30° C. to 230° C., more particularly from 30° C. to 200° C.

The silphenylene polymers of the invention may be obtained in principle by any processes which lead to bond formation between Si atoms and carbon atoms.

Typical representatives of such reactions are Grignard reactions, coupling reactions in the manner of the Wurtz synthesis, optionally with adaptations in the synthesis profile, and hydrosilylation reactions. All of these types of reaction are fundamentally prior art and therefore known to the skilled person. For a fundamental overview of not only these but also further organometallic reactions for the formation of Si—C bonds, reference may be made to the silicon chemistry module at the University of Freiburg, accessible using the following link: https://tu-freiberg.de/sites/default/files/media/institut-fuer-anorganische-chemie-10441/lehre/kroke/siliciumchemie5.pdf

Hints and information on the procedure in the case of Grignard syntheses can be found in, for example, Synthesis of Silphenylene-Containing Siloxane Resins Exhibiting Strong Hydrophobicity and High Water Vapor Barriers, Xunjun Chen, Minghao Yi, Shufang Wu, Lewen Tan, Yixin Xu, Zhixing Guan, Jianfang Ge and Guoqiang Yin, Coatings 2019, 9, 481.

For the preparation of the silphenylene polymers of the invention, it is necessary to observe the appropriate selection of the reaction conditions and of the raw materials. As already indicated in the discussion of the prior art, the hydrosilylation reaction is not preferred for the preparation of the silphenylene polymers of the invention.

EP 0913420 sets out the raw materials needed for realizing the hydrosilylation reaction for obtaining the silphenylene-silalkylene polymers described in EP 0913420. These are disilphenylenes and silphenylenes with olefinically unsaturated termination, or diunsaturated silanes. The corresponding silphenylene starting materials are accessible in turn through Grignard reactions. Nor would this be any different in the case of the silphenylene polymers of the invention here. This means that, relative to a Grignard synthesis or a Wurtz synthesis or any other procedure which supplies the silphenylene polymers of the invention directly, the hydrosilylation denotes a disadvantage due to additional steps, increased cost and complexity, and hence reduced profitability. Given that in the case of the present invention, moreover, there are not regularly alternating structural elements in the polymer framework, as is the case in EP 0913420, the polymers instead having a random composition, a relatively large number of suitable raw materials would be necessary for a successful hydrosilylation route to the silphenylene polymers of the invention, and possibly specific synthesis strategies allowing the composition according to the invention.

Overall, therefore, while the hydrosilylation reaction is in principle applicable for obtaining the silphenylene polymers of the invention, it entails considerable additional cost and complexity relative to processes such as the Wurtz or Grignard synthesis, for instance.

The hydrosilylation reaction is therefore not preferred as a synthesis pathway to the silphenylene polymers of the invention, in contrast to the silphenylene-silalkylene polymers and silphenylene-siloxane copolymers that are described in the known prior art. The new state of the art described here is realized at best with a process that differs from the preferred process according to the already known prior art.

The preferred process for preparing the silphenylene polymers of the invention involves magnesium-mediated Si—C bond formations in the manner of a Grignard reaction. Through this process it is possible to obtain the silphenylene polymers of the invention in a single process step and hence with maximum profitability, in the requisite purity.

For the preferred process for preparing the silphenylene polymers of the invention, silicon-containing compounds of the formulae (IV), (V) and (VI) are used,

R¹⁵ₕR¹⁶ᵢSi (IV),

R¹⁵ⱼR¹⁶ₖSi[SiRₗ¹⁷Rₘ¹⁸]ₙSiRⱼ¹⁵Rₖ¹⁶ (V),

R¹⁵ⱼR¹⁶ₖSi[SiRₗ¹⁷Rₘ¹⁸]ₙ—X¹—[SiRₗ¹⁷Rₘ¹⁸]ₙSiR¹⁵ⱼR¹⁶ₖ (VI),

where R¹⁵ is a halogen atom or a C1-C3 alkoxy group, preferably a chlorine, bromine or iodine atom or a methoxy radical, more particularly a Cl atom or a methoxy radical, where two or more radicals R¹⁵ may be different radicals from the stated group; in particular, two or more radicals R¹⁵ in the same molecule may be both a halogen radical and an alkoxy radical, and
R¹⁶, R¹⁷ and R¹⁸ may independently of one another be radicals from the group of the radicals R, R¹, R² or R³, but not a radical of the formula (II), and R¹⁸ may additionally be a halogen radical or a C1-C3 alkoxy radical, where the radicals R¹⁶, R¹⁷ and R¹⁸ contain no functional groups comprising carbonyl or carboxyl groups, hydroxyl groups, doubly bonded nitrogen atoms, primary, secondary or tertiary amine groups or thiol groups, so that the radicals R¹⁶, R¹⁷ and R¹⁸ are inert toward magnesium.

X¹ is a chemical bond or a magnesium-inert divalent bridging aliphatic, cycloalkylaliphatic, cycloalkylaromatic or an alkylaromatic hydrocarbon radical which contains no functional groups comprising carbonyl or carboxyl groups, hydroxyl groups, doubly bonded nitrogen atoms, primary, secondary or tertiary amine groups or thiol groups and produced by hydrosilylation of a hydrosilylatable, olefinically or acetylenically unsaturated precursor Z of the formula R¹⁹—X²—R¹⁹ in which R¹⁹ is a olefinically or acetylenically unsaturated, hydrosilylatable C2-C8 radical and X² is the radical X¹ shortened on either side by the C2-C8. Examples of cycloaliphatic, cycloaromatic or aromatic hydrocarbon radicals X² are those as already recited for Y, with the limitation that for X², the only radicals from the group of the radicals Y that are permissible are those which are inert toward magnesium.
h is an integer with a value of 1, 2, 3 or 4, preferably 1, 2 or 3, and
i is an integer with a value of 0, 1, 2 or 3 and the sum h+i=4.
j is a number with a value of 0, 1, 2 or 3, where j at least at one terminal Si atom of the di-, oligo- or polysilane of the formula (V) possesses a value of 1, that there is always at least at one radical R¹⁵ per molecule of the formula (V),
k is an integer with a value of 0, 1, 2 or 3, where k+j=3.
l and m are each a number with a value of 0, 1 or 2, where l+m=2.
n is a number with a value of 0 to 50, preferably 0-30.

The compounds of the formula (VI), which contain a radical X¹ which through hydrosilylation is bound to the Si atoms bordering it are preferably obtained by hydrosilylation of the precursor Z with Si—H-functional, silicon-containing compounds of the formula (VII)

R¹⁵ⱼR¹⁶ₖSi[SiRₗ¹⁷Rₘ¹⁸]ₙ—H (VII),

where R¹⁵, R¹⁶, R¹⁷ and R¹⁸, and also j, k, l and m have the definitions indicated above and H is a hydrogen atom. For n=0, (VII) is a halogenated silane or an alkoxy silane; for n>0, (VII) is a halogenated or an alkoxylated di-, oligo- or polysilane. Hybrid forms are also conceivable, in which case R¹⁵ is both a halogen radical and an alkoxy radical in the same molecule.

As well as raw material for the preparation of compounds of the formula (VI), the compounds of the formula (VII) may also be used for preparing the silphenylene polymers of the invention, in which case they are able, through the halogen radicals and/or the alkoxy radicals, to participate in the Grignard reaction used preferably for preparing the silphenylene polymers of the invention, preferably.

Typical examples of silanes of the formula (IV) are methyltrichlorosilane, methyltrimethoxysilane, methyltriethoxysilane, dimethyldichlorosilane, dimethyldichlorosilane, dimethyldiethoxysilane, trimethylchlorosilane, trimethylmethoxysilane, trimethylethoxysilane, trimethylsilanol, phenyltrichlorosilane, phenyltrimethoxysilane, phenyltriethoxysilane, phenylmethyldichlorosilane, phenylmethyldimethoxysilane, phenylmethyldiethoxysilane, diphenyldichlorosilane, diphenyldimethoxysilane, diphenyldiethoxysilane, triphenylchlorosilane, triphenylmethoxysilane, triphenylethoxysilane, diphenylmethylchlorosilane, diphenylmethoxysilane, diphenylmethyldiethoxysilane, phenyldimethylchlorosilane, phenyldimethylmethoxysilane, phenyldimethylethoxysilane, vinyltrichlorosilane, vinyltrimethoxysilane, vinyltriethoxysilane, vinyldimethylchlorosilane, vinyldimethylmethoxysilane and vinyldimethylethoxysilane, trichlorosilane, trimethoxysilane, triethoxysilane, methyldichlorosilane, methyldimethoxysilane, methyldiethoxysilane, dimethylchlorosilane, dimethylmethoxysilane, dimethylethoxysilane, ethyltrichlorosilane, ethyltrimethoxysilane, ethyltriethoxysilane and tetrachlorosilane. Particularly preferred silanes of the formula (IV) are methyltrichlorosilane, methyltrimethoxysilane, dimethyldichlorosilane, dimethyldimethoxysilane, vinyltrichlorosilane, vinyltrimethoxysilane, vinyldimethylchlorosilane, vinyldimethylmethoxysilane, phenyltrichlorosilane, phenyltrimethoxysilane, phenylmethyldichlorosilane and phenylmethyldimethoxysilane. The silanes of the formula (IV) may also be used in the form of mixtures. It is preferred, for example, that mixtures of silanes which for chain formation and crosslinking are used mixed with terminating silanes. The recitation of the examples is to be understood illustratively, not restrictively.

Typical examples of di-, oligo- and polysilanes of the formula (V) are hexachlorodisilane, hexamethoxydisilane, hexaethoxydisilane, dimethyltetrachlorodisilane, dimethyltetramethoxydisilane, dimethyltetraethoxydisilane, trimethyltrichlorodisilane, trimethyltrimethoxydisilane, trimethyltriethoxydisilane, tetramethyldichlorodisilane, tetramethyldimethoxydisilane, tetramethyldiethoxydisilane, dimethylvinyltrichlorodisilane, dimethylvinyltrimethoxydisilane, dimethylvinyltriethoxydisilane, diphenyltetrachlorodisilane, diphenyltrimethoxydisilane, diphenyltetraethoxydisilane, diphenylvinyltrichlorodisilane, diphenylvinyltrimethoxydisilane, diphenylvinyltriethoxydisilane, tetravinyldichlorodisilane, tetravinyldimethoxydisilane, tetravinyldiethoxydisilane, divinyltetrachlorodisilane, tetravinyldimethoxydisilane, tetravinyldiethoxydisilane, trimethyldichlorodisilane, trimethyldimethoxydisilane, trimethyldiethoxydisilane, octachlorotrisilane, octamethoxytrisilane, octaethoxytrisilane, tetramethyltetrachlorotrisilane, tetramethyltetramethoxytrisilane, tetramethyltetraethoxytrisilane, hexamethyldichlorotrisilane, hexamethyldimethoxytrisilane, hexamethyldiethoxytrisilane, pentamethyltrichlorotrisilane, pentamethyltrimethoxytrisilane, pentamethyltriethoxytrisilane, diphenyldivinyltetrachlorotrisilane, diphenyldivinyltetramethoxytrisilane, diphenyldivinyltetraethoxytrisilane, diphenyldimethylvinyltrichlorotrisilane, diphenyldimethylvinyltrimethoxytrisilane, diphenyldimethylvinyltriethoxytrisilane, tetramethyltrichlorotrisilane, tetramethyltrimethoxytrisilane, tetramethyltriethoxytrisilane, hexamethylchlorotrisilane, hexamethylmethoxytrisilane, hexamethylethoxytrisilane, pentamethyldichlorotrisilane, pentamethyldimethoxytrisilane, pentamethyldiethoxytrisilane, diphenyldivinyltrichlorotrisilane, diphenyldivinyltrimethoxytrisilane, diphenyldivinyltriethoxytrisilane, diphenyldimethylvinyldichlorotrisilane, diphenyldimethylvinyldimethoxytrisilane, diphenyldimethylvinyldiethoxytrisilane, nonamethylnonachlorooctasilane, nonamethylnonamethoxyoctasilane, nonamethylnonaethoxyoctasilane, heptamethyldiphenylnonachlorooctasilane, heptamethyldiphenylnonamethoxyoctasilane, heptamethyldiphenylnonaethoxyoctasilane, heptamethyldiphenyldivinylheptachlorooctasilane, heptamethyldiphenyldivinylheptamethoxyoctasilane, heptamethyldiphenyldivinylheptaethoxyoctasilane, heptamethyltetraphenylheptachlorooctasilane, heptamethyltetraphenylheptamethoxyoctasilane, heptamethyltetraphenylheptaethoxyoctasilane, in which the methyl, phenyl, ethyl, vinyl and Si—H groups and the chloro and/or methoxy and ethoxy groups may be distributed randomly over the silicon atoms, with compliance with the rule that each Si atom is tetravalent. The recitation is to be understood as illustrative, not restrictive. Instead of Si atoms only substituted purely by Cl atoms or methoxy or ethoxy groups, representatives with mixed Cl, methoxy and/or ethoxy functionality are also possible in the example molecules of the formula (V) and likewise belong to the typical examples.

Typical examples of di-, oligo- and polycarbosilanes of the formula (VI) are
Cl(CH₃)₂Si—CH₂CH₂—Si(CH₃)₂Cl, Cl₂(CH₃)Si—CH₂CH₂—Si(CH₃)₂Cl, Cl₂(CH₃)Si—CH₂CH₂—Si(CH₃)Cl₂, Cl₃Si—CH₂CH₂—SiCl₃,
Cl(CH₃)₂Si—CH═CH—Si(CH₃)₂Cl, Cl₂(CH₃)Si—CH═CH—Si(CH₃)₂Cl, Cl₂(CH₃)Si—CH═CH—Si(CH₃)Cl₂, Cl₃Si—CH═CH—SiCl₃,
Cl(CH₃)₂Si—(CH₂)₃(C₆H₄)(CH₂)₃—Si(CH₃)₂Cl, Cl₂(CH₃) Si—(CH₂)₃(C₆H₄)(CH₂)₃—Si(CH₃)₂Cl, Cl₂(CH₃)Si—(CH₂)₃(C₆H₄)(CH₂)₃—Si(CH₃)Cl₂, Cl₃Si—(CH₂)₃(C₆H₄)(CH₂)₃—SiCl₃,
Cl(CH₃)Si—Si(CH₃)₂—(CH₂)₃(C₆H₄)(CH₂)₃—(CH₃)₂Si—Si(CH₃)₂Cl,
Cl(CH₃)₂Si—(CH₂)₃(C₆H₄)—(C₆H₄)(CH₂)₃—Si(CH₃)₂Cl, Cl₂(CH₃)Si—(CH₂)₃(C₆H₄)—(C₆H₄)(CH₂)₃—Si(CH₃)₂Cl, Cl₂(CH₃)Si—(CH₂)₃(C₆H₄)—(C₆H₄)(CH₂)₃—Si(CH₃)Cl₂, Cl₃Si—(CH₂)₃(C₆H₄)—(C₆H₄)(CH₂)₃—SiCl₃,
Cl(CH₃)₂Si—CH₂CH₂—Si(CH₃)(CH═CH₂)Cl, Cl(CH₃)(CH═CH₂)Si—CH₂CH₂—Si(CH₃)(CH═CH₂)Cl, Cl(CH₃)(CH═CH₂)Si—(CH₂)₃(C₆H₄)(CH₂)₃—Si(CH₃)(CH═CH₂)Cl,
Cl(CH═CH₂)₂Si—(CH₂)₃(C₆H₄)(CH₂)₃—Si(CH═CH₂)₂Cl, Cl(CH₃)(H)Si—(CH₂)₃(C₆H₄)(CH₂)₃—Si(CH₃)(H)Cl, Cl(H)₂Si—(CH₂)₃(C₆H₄)(CH₂)₃—Si(H)₂Cl,
   where in each case, instead of the chlorine atoms, methoxy groups or ethoxy groups may be included in the example molecules of the formula (VI), and possibly there may also be representatives formed which have mixed Cl, methoxy and/or ethoxy functionality and which likewise belong to the typical examples. The recitation is to be understood illustratively, not limitingly.

Organic raw materials which are suitable for the preparation of the silphenylenes of the invention are those of the formula (VIII)

[Hal]ₒ-Y (VIII),

where Hal is a Cl, Br or iodine atom, preferably a Cl or a Br atom, o is a number from 2 to 12, preferably 2, and Y has the definitions indicated for it above.

Typical examples of organic raw materials of the formula (VIII) arise from the recitation of the examples for the radical Y, with the free valences being saturated by halogen atoms. Especially preferred representatives of the formula (VIII) are dihalobenzenes, such as 1,4-dibromobenzene, 1,4-dicholorobenzene, 1,2-dicholorobenzene, 1,2-dibromobenzene, 1,2-dichloroethane, 1,2-dibromoethane, 1,1-dichloroethane, 1,1-dibromoethane, 1,4-dichlorobutane, 1,4-dibromobutane, 1,3-dichlorobutane, 1,3-dibromobutane, 1,5-dichloropentane, 1,5-dibromopentane, 1,6-dichlorohexane, 1,6-dibromohexane, 1,7-dichloroheptane, 1,7-dibromoheptane, 1,8-dichlorooctane, 1,8-dibromooctane, 1,9-dichlorononane, 1,9-dibromononane, 1,10-dichlorodecane, 1,10-dibromodecane, 1,11-dichloroundecane, 1,11-dibromoundecane, 1,12-dichlorododecane, 1,12-dibromododecane, 1,2-dichlorodiphenylethane, 1,2-dibromodiphenylethane, 1,2-dichlorocyclohexylethane, 1,2-dibromocyclohexylethane, 2-methyl-1,4-dicholorobenzene, 2-methyl-1,4-dibromobenzene, 2-methoxy-1,4-dicholorobenzene, 2-methoxy-1,4-dibromobenzene, 2-ethyl-1,4-dicholorobenzene, 2-ethyl-1,4-dibromobenzene, 2-ethoxy-1,4-dicholorobenzene, 2-ethoxy-1,4-dibromobenzene, 2-n-propyl-1,4-dicholorobenzene, 2-n-propyl-1,4-dibromobenzene, 2-n-propoxy-1,4-dicholorobenzene, 2-n-propoxy-1,4-dibromobenzene, 2-isopropyl-1,4-dicholorobenzene, 2-isopropyl-1,4-dibromobenzene, 2-n-butyl-1,4-dicholorobenzene, 2-n-butyl-1,4-dibromobenzene, 2-sec-butyl-1,4-dicholorobenzene, 2-sec-butyl-1,4-dibromobenzene, 2-tert-butyl-1,4-dicholorobenzene, 2-tert-butyl-1,4-dibromobenzene, polyhalogenated biphenylenes such as dibromobiphenyl, tribromobiphenyl, tetrabromobiphenyl, pentabromobiphenyl, hexabromobiphenyl, heptabromobiphenyl, octabromobiphenyl, nonabromobiphenyl, decabromobiphenyl and the corresponding polychlorinated biphenylene analogues, 4-chlorobenzhydryl chloride, 4-bromobenzhydryl bromide, diphenyldichloromethane, diphenyldibromomethane, 1,2-diphenyl-1,2-dichloroethane, 1,2-diphenyl-1,2-dibromoethane, 1,1′-(2,2,2-trichloroethane-1,1-diyl)bis(4-chlorobenzene), hexachlorocyclohexane, 1,2,4,5,6,7,8,8-octachloro-3a,4,7,7a -tetrahydro-4,7-methanoindane (chlordane), 1,2,3,4, 10,10-hexachloro-6,7-epoxy-1,4,4a,5,6,7,8,8a-octahydro-1,4-endo-5,8-exo-dimethanonaphthalene (dieldrin), 1-bromo-4-chlorobenzene, 4,4′-(propane-2,2-diyl)bis(2,6-dibromophenol) (tetrabromobisphenol A), 3,5,3′,5′-tetrachlorobisphenol A.

Preferred representatives of the formula (VIII) are 1,4-dibromobenzene, 1,4-dicholorobenzene, 1,2-dichloroethane and 1,2-dibromoethane. It is possible optionally to use mixtures of different representatives of the formula (VIII).

The recitation, like all other recitations of typical examples, is to be understood illustratively and not limitingly.

The magnesium is used as metal conveniently in forms with a large surface area, i.e., in the form, for example, of turnings, grains or powder. The magnesium is used preferably in a minimum amount dictated by the following equation: p=(q/2)+r. Here, p denotes the number of moles of magnesium, q the number of the halogen and alkoxy equivalents from the compounds (IV), (V), (VI), (VII) and (VIII), and r a value between 0 and half of the respectively employed amount of halogen and alkoxy equivalents from the compounds (IV), (V), (VI), (VII) and (VIII), with an r value of 0 being not included. In other words, r is always greater than zero and has a maximum value of q/2. Magnesium is used in excess relative to the number of halogen atoms and alkoxy groups.

In order to facilitate the reaction, solvents which are inert toward the reaction participants are employed in the preferred process for preparing the silphenylene polymers of the invention. Here it is possible in principle to use the substances typically employed as inert solvents in the reaction of metals with organohalogen compounds, these being more particularly ethers such as diethyl ether, di-n-butyl ether, tert-butyl methyl ether, tetrahydrofuran, 1,4-dioxane, or hexamethylphosphoramide, which may be used optionally also in a mixture with one another and optionally also in a mixture with further inert solvents such as toluene, xylene or ethylbenzene. In that case, however, it should be ensured that the solvents used are also actually inert toward the reaction participants. It has been found, for example, that Si—Cl-containing components of the formulae (IV), (V), (VI) and (VII) react with THF with ring opening, forming butoxy groups which are inserted by reaction into the silphenylene polymers as they form, and which form unwanted alkoxy groups, which may in principle react for the hydrolysis to form silanol groups, which may in turn undergo condensation to form likewise unwanted Si—O—Si units. As will be seen later, working up is operated aqueously, optionally using acids such as hydrochloric acid, and so this reaction is possible during working up. This secondary reaction would produce silphenylene-polysiloxane copolymers not in accordance with the invention.

In the prior art directed to the preparation of silphenylene-polysiloxane polymers containing polysiloxane units, such as according to U.S. Pat. No. 3,350,350 A, for example, no attention is paid to this circumstance, since in that case the formation of siloxane units is not inconsistent with the invention. In the present case, however, this is different, and herein lies, in detail, the novelty of the selected process for preparing the silphenylene polymers of the invention. In the present case, together with Si—Cl-containing components of the formulae (IV), (V), (VI) and (VII), the only candidate solvents are those which, like 1,4-dioxane and hexamethylphosphoramide, are inert toward chlorosilanes. The use of, for example, THF is indeed possible, but only together with alkoxy-functional components of the formulae (IV), (V), (VI) and (VII).

The preferred process for preparing the silphenylene polymers of the invention is performed preferably at temperatures from −78° C. to 150° C. under atmospheric pressure. Optionally, higher or lower pressures may also be employed. The process is conveniently performed in an atmosphere, inert toward the reaction participants, composed of nitrogen or argon, where best possible practice is to rule out in particular the ingress of water as liquid, vapor or coating on vessels and also on the magnesium, by applying suitable prior-art measures, such as baking under reduced pressure, for example.

The preferred process for preparing the silphenylene polymers of the invention is preferably performed in stages, by first reacting the component (VIII) with magnesium and in the second step adding the respectively required selection of components (IV), (V), (VI) and (VII). The process, however, may also be performed in one step, with the components of the formula (VIII) being reacted in the presence of the required selection from the components of the formula (IV), (V), (VI) and optionally (VII). To activate the magnesium it is advantageous first to combine a portion of component (VIII), of 10 weight % of the total amount of component (VIII), for example, with the magnesium first.

The reaction products obtained in the preferred process may be isolated in the same way as is usual for the isolation of reaction products obtained in organometallic syntheses, especially Grignard syntheses. The reaction mixtures obtained are preferably mixed with water at 0 to 30° C. Since in this case, from Si—Cl groups that are still present, hydrochloric acid is formed and silanol groups are produced that lead to condensation and to the formation of Si—O—Si units, both of which are unwanted, complete or very near complete conversion of all of the halogen radicals involved in the reaction should be ensured prior to working up. The same applies to Si-bonded alkoxy groups still present during the addition of water. These groups as well may hydrolyze and form silanol groups capable of condensation. For this reason, in contrast to prior-art, Grignard-analogous syntheses for the preparation of polysilarylenesiloxanes, for example, according to U.S. Pat. No. 3,350,350 A, the amount of magnesium used in the present case is not that which is equivalent to the amount of halogen atoms and alkoxy groups employed; instead, a magnesium excess is used. A possibility, optionally, is to use an acid for working up as well, such as hydrochloric acid, for instance, in order to adjust the pH or to promote the formation of magnesium halides.

The water-soluble salt constituents undergo aqueous extraction, while solids, such as possibly insoluble fractions of magnesium or salts of magnesium, are removed by prior-art methods, such as by filtration or centrifugation, for example.

The volatile constituents of the reaction mixture are removed by means of prior-art techniques, such as continuous or batchwise distillation, for example, in order to obtain the reaction products in pure form. If the reaction products are desired as a preparation in a solvent, they may be dissolved subsequently in the solvent of choice or else obtained directly as the desired preparation by a solvent exchange from the reaction solvent. The solvent exchange as well takes place according to known prior-art techniques.

If it is desirable for the silphenylene polymers obtained as primary products from the preferred process to be modified further, through the introduction, for example, of functional groups which are not stable toward the conditions of the Grignard synthesis, it may be advantageous to introduce suitable functional groups into the primary silphenylene polymer in the Grignard-analogous synthesis step. In this case it should be borne in mind that the silphenylene polymers obtained primarily as such already fulfill all of the features of inventiveness and are therefore invention-compliant in accordance with the present invention. From the prior art it is known that the carbonyl groups of aldehydes, ketones and carboxylic acids, and also their esters, are converted into alcohols by Grignard reactions. Therefore, should there be a desire for carbinol groups for subsequent introduction of functional groups, one possibility for this would be to use correspondingly carbinol-functional starting materials and to use carbonyl- or epoxy-functional starting materials, through the selection, for example, of a suitable component of formula (VIII). Since Grignard reagent is consumed both in the presence of alcohol and in the reaction of the carbonyl groups, the extra requirement for Grignard reagent must be borne in mind. Given that this procedure might in certain circumstances jeopardize the economics of the process, this procedure is not preferred, although it is in principle possible and is therefore included as in accordance with the invention.

Through the reaction of acryloyl, methacryloyl or chloropropionyl chloride with a carbonyl group of this kind, it is possible, for example, for an acrylate group or a methacrylate group to be introduced into a silphenylene polymer of the invention. In the case of the reaction with the acyl chlorides of methacrylic acid and of acrylic acid, the corresponding methacrylic or acrylic ester is formed after elimination of HCl, which may optionally be promoted using a suitable amine such as a tertiary amine, for example. In the case of chloropropionyl chloride, the product of the first step is the ester of chloropropionic acid, from which in the second step the acrylic acid radical is formed by basic working up using, for example, a tertiary amine, and by elimination of HCl from the propionyl chloride radical. All reactions are as such prior art and therefore per se not novel. Their use for the preparation of the silphenylene polymers that are subject-matter of the invention, however, is novel, and consequently these steps are included in the scope of the invention as a constituent of the preferred process for preparing the silphenylene polymers of the invention.

The silphenylene polymers of the formula (I) all possess at least olefinically or acetylenically unsaturated functional groups via which they are chemically crosslinkable. Possible chemical crosslinking reactions here include the known prior-art reactions, more particularly radical crosslinking, which may be initiated either using suitable radiation sources such as UV light or by means of unstable chemical compounds that break down into radicals, and addition crosslinking, by means, for example, of hydrosilylation of the olefinically unsaturated group with an Si—H function in the presence of a suitable hydrosilylation catalyst. The Si—H functions as well may be bound to the silphenylene polymers of the invention.

In order to achieve sufficient curing, there must be a sufficient amount of functional groups present. At the least there must be on average 1.0 functional groups present per silphenylene polymer molecule used in the invention, in order to achieve sufficient curing; preferably there are on average at least 1.1, more particularly on average at least 1.2, functional groups present per silphenylene polymer molecule of the invention. The functional groups here may be different, with, for example, some of the functional groups being an Si—H group and some other of the functional groups representing an olefinically unsaturated group which is radically curable or amenable to hydrosilylation. Further combinations of complementary functional groups are conceivable as well, with “complementary” meaning that the chosen combinations of functional groups are able to react with one another. If only one kind of functional groups is present—for example, only functional groups with olefinic or acetylenic unsaturation—that are radically curable, then there must be the corresponding number of these functional groups. In the sense of copolymerization to form a homogeneous matrix, it should be ensured here that there is sufficient copolymerizability on the part of the chosen olefinic and acetylenic groups. The combination of olefinic groups which are not copolymerizable with one another is also possible, provided the matrix obtained, comprising two or possibly more individual polymers, remains mutually compatible and does not form separate phases which separate from one another into distinguishable domains.

Examples of suitable initiators for commencing the radical polymerization include here, in particular, examples from the field of the organic peroxides, such as di-tert-butyl peroxide, dilauryl peroxide, dibenzoyl peroxide, dicumyl peroxide, cumyl peroxyneodecanoate, tert-butyl peroxyneodecanoate, tert-amyl peroxypivalate, tert-butyl peroxypivalate, tert-butyl peroxyisobutyrate, tert-butyl peroxy-3,5,5-trimethylhexanoate, tert-butyl cumyl peroxide, tert-butyl peroxyacetate, tert-butyl peroxybenzoate, 1,1-di-tert-butylperoxycyclohexane, 2,2-di(tert-butylperoxy)butane, bis(4-tert-butylcyclohexyl) peroxydicarbonate, hexadecyl peroxydicarbonate, tetradecyl peroxydicarbonate, dibenzyl peroxydicarbonate, diisopropylbenzene, dihydroperoxide, [1,3-phenylenebis(1-methylethylidene)]bis[tert-butyl]peroxide, 2,5-dimethyl-2,5-di-(tert-butylperoxy)hexane, dicetyl peroxydicarbonate, acetylacetone peroxide, acetyl cyclohexanesulfonyl peroxide, tert-amyl hydroperoxide, tert-amyl peroxy-2-ethylhexanoate, tert-amyl peroxy-2-ethylhexyl carbonate, tert-amyl peroxyisopropyl carbonate, tert-amyl peroxyneodecanate, tert-amyl peroxy-3,5,5-trimethylhexanoate, tert-butyl monoperoxymaleate, this recitation being only illustrative and not restrictive. It is also possible, optionally, to use mixtures of different initiators for radical reactions.

The suitability of an initiator or initiator mixture for radical reactions is dependent on its decomposition kinetics and the requirement conditions to be met. By adequately observing these boundary conditions, the skilled person is able to make the appropriate selection of an initiator.

In the case of preparations which as well as olefinically and acetylenically unsaturated groups also contain silicon-bonded hydrogen, the possibility exists of curing through a hydrosilylation reaction. Suitable catalysts for promoting the hydrosilylation reaction are the known catalysts from the prior art.

Examples of such catalysts are compounds or complexes from the group of the precious metals, comprising platinum, ruthenium, iridium, rhodium and palladium, preferably metal catalysts from the group of the platinum metals or compounds and complexes from the group of the platinum metals. Examples of such catalysts are metallic and finely divided platinum, which may be present on supports such as silicon dioxide, aluminum oxide or activated carbon, and compounds or complexes of platinum such as platinum halides, e.g., PtCl₄, H₂PtCl₆x6H₂O, Na₂PtCl₄x4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₄x6H₂O and cyclohexano, platinum-vinyl-siloxane complexes, such as platinum-1,3-divinyl-1,1,3,3-tetramethyldisiloxane, with or without detectable inorganically bonded halogen present, bis(gamma-picoline)platinum chloride, trimethylenedipyridineplatinum chloride, dicyclopentadieneplatinum dichloride, dimethylsulfoxyethenylplatinum(II) dichloride, cyclooctadieneplatinum dichloride, norbornadieneplatinum dichloride, gamma-picolineplatinum dichloride, cyclopentadieneplatinum dichloride, and reaction products of platinum tetrachloride with olefin and primary or secondary amine or primary and secondary amine such as the reaction product of platinum tetrachloride in solution in 1-octene with sec-butylamine, or ammonium-platinum complexes. A further embodiment of the process of the invention uses complexes of iridium with cyclooctadienes, such as μ-dichlorobis(cyclooctadiene)diiridium(I), for example.

This recitation is only illustrative and not restrictive.

The development of hydrosilylation catalysts is a dynamic research field which is continually bringing forth new active species, which of course may likewise be used here.

The hydrosilylation catalyst preferably comprises compounds or complexes of platinum, preferably platinum chlorides and platinum complexes, more particularly platinum-olefin complexes, and with particular preference platinum-divinyltetramethyldisiloxane complexes.

In the process of the invention, the hydrosilylation catalyst is used in amounts of 2 to 250 ppm by weight, preferably in amounts of 3 to 150 ppm, more particularly in amounts of 3 to 50 ppm.

In one preferred embodiment, the silphenylene polymers of the formula (I) in a third step are applied to a metal substrate.

The silphenylene polymers of the formula (I) are especially suitable for use as binders and/or as adhesion promoters for the production of metal-clad laminates, particularly for electronic applications, especially for metal-faced laminates, and particularly for use in radiofrequency applications, especially those which are operated at frequencies of 1 GHz and above. Particular preference is given to the production of metal-faced electrolaminates, of the kind used for production as circuit boards in electronic devices, especially for radiofrequency applications.

Said metal-faced electrolaminates may contain reinforcing materials, but need not do so. This means that they may be free from or may contain, for example, reinforcing fabrics such as fiber wovens or nonwovens. If a reinforcing material is included, it is preferably arranged in layers. A reinforcing layer in this case may be constructed from a multiplicity of different fibers.

Reinforcing layers of these kinds help to control the shrinkage characteristics and provide enhanced mechanical strength.

If a reinforcing layer is used, the fibers which form this layer may be selected from a multiplicity of different possibilities. Nonlimiting examples of such fibers are glass fibers, such as, for example, E-glass fibers, S-glass fibers and D-glass fibers, silica fibers, polymer fibers, such as, for example, polyetherimide fibers, polysulfone fibers, polyetherketone fibers, polyester fibers, polycarbonate fibers, aromatic polyamide fibers, or liquid-crystalline fibers. The fibers may have a diameter of 10 nm to 10 μm. The reinforcing layer has a thickness of at most 200 μm, preferably at most 150 μm. One preferred form of application is the use of the silphenylene polymers of the formula (I) as binders or cobinders together with organic binders for producing metal- faced laminates comprising glass fiber composites for the further production of circuit boards. The preferred metal is copper.

For the use of the silphenylene polymers of the formula (I) in accordance with the invention, they may be used as the sole binder. They may also be used in a form blended with organic monomers, oligomers and polymers.

Organic monomers, oligomers and polymers typically used for this purpose comprise polyphenylene ethers, bismaleimides, bismaleimide-triazine copolymers, hydrocarbon resins, both aliphatic such as polybutadiene and aromatic such as polystyrene, for example, and also hybrid systems, possessing both aliphatic and aromatic character, such as styrene-polyolefin copolymers, for example, there being in principle no limitation on the form of the copolymers; epoxy resins, cyanate ester resins, and optionally others, the selection being illustrative and nonlimiting.

Preferred organic monomers, oligomers and polymers are oligomeric and polymeric polyphenylene ethers, monomeric, oligomeric and polymeric bismaleimides, oligomeric and polymeric hydrocarbon resins, and bismaleimide-triazine copolymers. Here, the organic monomers, oligomers and polymers may optionally be used as mixtures with one another.

The proportion of the organic monomers, oligomers and polymers in the preparations with the silphenylene polymers of the formula (I), where the organic components are also used, is between 10% and 90%, based on the mixture of the silphenylene polymers of the formula (I) and the organic monomers, oligomers and polymers as 100%, preferably 20%-90%, more particularly 30%-80%.

Furthermore, not only the silphenylene polymers of the formula (I) but also the mixtures thereof with organic monomers, oligomers or polymers may be dissolved in further organic monomers, optionally with olefinically or acetylenically unsaturated groups, as reactive diluents, such as, for example, styrene, alpha-methylstyrene, para-methylstyrene and vinylstyrene, chloro- and bromostyrene.

It is also possible to use typical nonreactive solvents for dissolving the silphenylene polymers of the formula (I) and optionally mixtures thereof with organic monomers, oligomers and polymers, such as, for example, aliphatic or aromatic solvents such as aliphatic mixtures with defined boiling ranges, toluene, xylene, ethylbenzene or mixtures of these aromatics, ketones, such as acetone, methyl ethyl ketone, cyclohexanone, carboxylic esters, such as ethyl acetate, methyl acetate, ethyl formate, methyl formate, methyl propionate, ethyl propionate; effective solubility particularly of the mixtures of silphenylene polymers of the formula (I) with organic monomers, oligomers and polymers is most likely to be achieved in aromatic solvents such as toluene, xylene, ethylbenzene and mixtures thereof.

In the event that the silphenylene polymers of the formula (I) are used in combination with an organic oligomer or polymer or mixtures thereof, it is essential that silphenylene polymers of the formula (I) are used which are compatible with the organic components of choice and which do not lead to phase separations. In these events, in general, more phenyl-rich silphenylene polymers of the formula (I) should be used, since phenyl groups increase compatibility with the organic components. Especially with relatively aromatic-rich organic polymers such as polyphenylene ethers or aromatic hydrocarbon resins, more aromatic-rich silphenylene polymers of the formula (I) should be used, with the bridging aromatic groups and aromatic substituents bonded terminally on silyl units both contributing to the establishment of compatibility.

The precise amount of the aromatic groups that is needed to establish compatibility of the silphenylene polymers of the formula (I) with a defined selection of organic binders must be ascertained depending on the selection of organic binders.

Just as it is possible to mix two or more organic polymers, selected optionally from different polymer classes, and to use them in the binder preparation, it is also possible to combine two or more silphenylene polymers of the formula (I) with one another in a binder preparation. In other words, in accordance with the invention, use may be made either of only single silphenylene polymer of the formula (I) as binder, or else two or more silphenylene polymers of the formula (I) may be combined with one another to form a binder preparation. It is also in accordance with the invention to combine only one silphenylene polymer of the formula (I) with one or more organic polymers to form a binder preparation. It is also in accordance with the invention to combine two or more silphenylene polymers of the formula (I) with one or more different organic polymers to form a binder preparation.

Determining the compatibility of one or more silphenylene polymers of the formula (I) with one or more organic oligomers or polymers is easily accomplished by mixing a mixture of the one or more organic binders with the one or more silphenylene polymers of the formula (I), advantageously in a solvent which dissolves all of the selected components, and then removing the solvent by prior-art techniques, such as by distillation or spray-drying, for example, and subjecting the resulting residue to visual evaluation or evaluation with the aid of microscopic techniques, possibly electron microscopy techniques. Compatible mixtures are apparent from the absence of any silphenylene polymer domains which separate from the organic constituents and are recognizable as an independent phase.

The use of further formulating components, such as additives, which optionally may also include silanes, such as, for example, antifoams and deaerating agents, wetting and dispersing agents, flow control agents, compatibilizers, adhesion promoters, curing initiators, catalysts, stabilizers, fillers including pigments, dyes, inhibitors, flame retardants, crosslinking assistants, etc., is in accordance with the invention, and there is in principle no limitation on the selection of such components. Aside from tests of the compatibility in the sense of a suitable miscibility behavior, tests of compatibility in terms of reactivity may also be necessary, in order both to prevent premature gelling and to ensure that on curing there is sufficiently rapid polymerization or copolymerization of all the components with one another, and also tests for sufficient wetting and optionally further properties. This may need to be borne in mind and taken into account when drawing up the formulation.

Examples of fillers which can be used are ceramic fillers such as, for instance, silicas, for example precipitated silicas or fumed silicas, which may be either hydrophilic or hydrophobic and are preferably hydrophobic and which, furthermore, may also be equipped functionally, and optionally reactively, with organic groups on their surface; quartz, which may optionally have been surface-treated or surface-functionalized, allowing it to carry reactive functional groups on the surface; aluminum oxides, aluminum hydroxides, calcium carbonate, talc, mica, alumina, kaolin, magnesium sulfate, carbon black, titanium dioxide, zinc oxides, antimony trioxide, barium titanate, strontium titanate, corundum, wollastonite, zirconium tungstate, hollow ceramic beads, aluminum nitride, silicon carbide, beryllium oxide, magnesium oxide, magnesium hydroxide, solid glass beads, hollow glass beads and boron nitride. Further fillers used may be core-shell particles of various materials, such as, for instance, silicone resin beads with a surface covering of silica, and elastomer particles with a covering of polymer, in which case the elastomer particles may optionally also be silicone elastomers, and a typical example of surface covering on an elastomer particle of this kind is a polymethyl methacrylate shell. The ceramic fillers preferably have particle sizes, expressed as D₉₀, of 0.1 μm to 10 μm. Fillers are present preferably in amounts of 0.1 to 60 weight percent, more preferably of 0.5 to 60 weight percent, more particularly of 1 to 60 weight percent, based on the overall binder formulation consisting of binder or binders, reactive monomers, additives and fillers as 100%. This means that the amount of any nonreactive solvent used is not included.

Among the fillers, particular emphasis should be given to those which have thermal conductivity. These are aluminum nitride, boron nitride, silicon carbide, diamond, graphite, beryllium oxide, zinc oxide, zirconium silicate, magnesium oxide, silicon oxide and aluminum oxide.

In principle, the binder preparations may comprise flame retardant additives in an amount of typically 5 to 25 weight percent. A particular feature of the silphenylene polymers of the formula (I), however, is that they reduce the requirement for flame retardant additives, as the silphenylene polymers of the formula (I) themselves already exhibit flame retardancy properties. Polyorganosiloxanes and siloxanes are known for exhibiting flame retardancy properties, which are also encountered with the silphenylene polymers of the invention, and so they themselves can be used as flame retardant additives. It is therefore a particular advantage of the present invention that in this case the function of the binder can be linked with the function of flame retardancy. Depending on the amount of silphenylene polymers of the formula (I) used, therefore, the amount of flame retardant additives can be reduced. For an amount of at least 20 weight percent, based on the total mixture of all the binders and reactive organic monomers used, the amount of flame retardant additives is preferably only 0 to 10 weight percent, more preferably 0 to 8 weight percent, more particularly 0 to 5 weight percent; in other words, it is possible when using the silphenylene polymers of the formula (I), depending on the selection thereof and on the amount employed, to omit the use of a flame retardant additive.

Typical examples of flame retardant additives are hydrates of the metals Al, Mg, Ca, Fe, Zn, Ba, Cu or Ni and borates of Ba and Zn. The flame retardant additives may be surface-treated, in which case they may optionally possess reactive groups on the surface. The flame retardant additives may also be halogenated organic flame retardant additives, such as, for example, hexachloroendomethylenetetrahydrophthalic acid, tetrabromophthalic acid or dibromoneopentyl glycol. Examples of further flame retardant additives are melamine cyanurate, phosphorus-containing components, such as phosphinates, diphosphinates, phopsphazenes, vinylphosphazenes, phosphonates, phosphaphenanthrene oxides, and fine-granular melamine polyphosphates. Further examples of bromine-containing flame retardant additives are bispentabromophenylethane, ethylenebistetrabromophthalimide, tetradecabromodiphenoxybenzene, decabromodiphenyl oxide or brominated polysilsesquioxanes. Certain flame retardant additives are boosted synergistically in their effect. This is the case, for example, for the combination of halogenated flame retardancy additives with antimony trioxide.

Further examples of other components are antioxidants, stabilizers against degradation by weathering, lubricants, plasticizers, coloring agents, phosphorescent or other agents for labelling and traceability, and antistatic agents.

The silphenylene polymers of the formula (I) are preferably crosslinked as part of the production of metal-faced laminates.

Crosslinking assistants employed include, in particular, polyunsaturated, radically curable or hydrosilylatable monomers and oligomers, as illustrated in nonlimiting examples below. They include, for example, diolefinically unsaturated components such as, for example, symmetrically olefinically unsaturated disubstituted disilanes, such as 1,1,2,2-tetramethyl-1,2-divinyldisilane, 1,1,2,2-tetramethyl-1,2-dipropylmethacryloyldisilane, diolefinically unsaturated disubstituted organic monomers or oligomers with, for example, diallyl, divinyl, diacryloyl or dimethacryloyl substitution, such as, for example, conjugated and nonconjugated dienes, such as 1,9-decadiene, 1,3-butadiene. They also include triolefinically unsaturated monomers or oligomers such as 1,2,4-trivinylcyclohexane, triallyl cyanurates or triallyl isocyanurates, tri(meth)acrylates, such as trimethylolpropane trimethacrylate, for example.

Also included here are monomers and oligomers with unsaturated substitution such as, for example, 2,2-bis[[(2-methyl-1-oxoallyl)oxy]methyl]-1,3-propanediyl bismethacrylate (pentaerythritol tetramethacrylate), tetraallyl cis,cis,cis,cis-1,2,3,4-cyclopentanetetracarboxylate, tetraallylsilanes, glyoxal bis (diallylacetal).

Because of the conceivable possibility of hydrosilylation curing in addition to radical curing, multiply Si—H-functional components may also act as crosslinkers, such as, for example, 1,1,2,2-tetramethyl-1,2-disilane, 1,4-bis(dimethylsilyl)benzene or oligo- and polyorganosilanes which have multiple in-chain and/or terminal Si—H functionality. Suitable catalysts and initiators for the radical curing of the binder preparations composed of silphenylene polymers of the formula (I) and organic monomers, oligomers and polymers are the same as those already identified earlier on above—thus, in particular, peroxides. Furthermore, for initiating the radical curing both of the silphenylene polymers of the formula (I) alone and of the binder preparations described, there are further radical initiators that are suitable, such as, for example, azo components, such as α,α′-azobis(isobutyronitrile), redox initiators such as combinations of peroxides such as hydrogen peroxide and iron salts, or azides such as acetyl azide, for example.

The silphenylene polymers of the formula (I) and the preparations comprising them may be used either as a solvent-free or as a solvent-containing preparation for use in accordance with the invention. In general they are used as a solvent-containing preparation, in order to facilitate the homogeneous distribution of all of the components of the formulation in one another and to facilitate the wetting and saturation of any reinforcing layer used. In general, a reinforcing layer is also used. It is preferably a glass fiber fabric. The saturation of the reinforcing layer may be accomplished by impregnative application of the preparation, for which there are various technical solutions available, including, optionally, continuous processes, the selection of which for the purpose of producing the metal-faced laminates of the invention is not limited in any way. Nonlimiting examples of application technologies are immersion, where appropriate of webs of the reinforcing material via roller systems in continuous operations, spraying, flow coating, knife coating, etc. It is an advantage of the present invention that all of the technologies available can be employed without limitation and modification, and no special new process is needed for the use of the silphenylene polymers of the formula (I). Accordingly, in the production of the metal-faced laminates, the present invention is entirely within the available state of the art. The new feature is the use of the silphenylene polymers of the formula (I) for producing the metal-faced laminates in question, which was hitherto unknown.

The impregnating is followed by a drying step, in which any solvent used is removed. For the drying operation as well, prior-art techniques are employed. These techniques encompass, in particular, thermally induced evaporation with or without reduced pressure. By appropriate setting of the reactivity and of the tack of the binder mixture used, the products of this step under suitable conditions, such as cooling, for example, are storable composite materials, which may optionally be processed further at a later point in time.

In a last step in the process, the binder preparation is polymerized, again according to prior-art techniques. Any initiators of the radical polymerization that are used here are heated beyond their decomposition temperature, and so they break down, forming radicals, and initiate the radical polymerization of the binder preparation. In principle, techniques of radiation curing can also be employed.

If hydrosilylation curing is used instead of radical polymerization, the temperature to be employed in this step is one suitable for deactivating the inhibitor used with the hydrosilylation catalyst used, and for releasing the catalytic activity of the hydrosilylation catalyst.

This step takes place in general at an elevated temperature of preferably 100 to 390° C., more preferably of 100 to 250° C., more particularly of 130 to 200° C., with the temperature being effective for a time of preferably 5 to 180 min, more preferably of 5 to 150 min, more particularly 10 to 120 min. It is also customary in this step to employ elevated pressure. Customary pressures are in the range from 1 to 10 MPa, more preferably from 1 to 5 MPa, more particularly from 1 to 3 MPa.

The lamination of the composite material with a conductive metal layer takes place in this second step, by application of a layer of at least one selected metal to one or both sides of the composite material composed of reinforcing layer and binder preparation, before curing takes place. In other words, between the first step, consisting of impregnating and drying, and the second step, comprising the chemical curing of the binder preparation, the composite from the first step is laminated with at least one variety of a conductive metal.

Suitable conductive metals include in particular at least one from the following selection: copper, stainless steel, gold, aluminum, silver, zinc, tin, lead and transition metals. There are in principle no limitations on the thickness of the conductive layer or on its shape, size or surface texture. The conductive metal layer preferably has a thickness of 3 to 300 μm, more preferably of 3 to 250 μm, more particularly of 3 to 200 μm. Where two layers are used, the thickness of the two layers of at least one variety of a conductive metal may vary and need not be identical. With particular preference, the conductive metal is copper and, in the event that two conductive layers of conductive metal are used, both layers are copper. The conductive metal is used preferably in the form of a foil of the metal in question. The mean roughness Ra of the metal foil used is preferably at most 2 μm, more preferably at most 1 μm, more particularly at most 0.7 μm. The lower the surface roughness, the better the suitability of the respective foil for use in radiofrequency applications, which are the preferred objective of the present invention. To improve the adhesion between the conductive metal layer and the composite composed of binder preparation and reinforcing layer, it is possible optionally to use various techniques from the prior art, such as, for example, the use of an adhesion-promoting layer, the electrochemical deposition of the metal layer on the composite composed of binder preparation and reinforcing layer, or vapor deposition. The layer of conductive metal may sit directly on the composite composed of binder preparation and reinforcing layer, or may be joined to it via an adhesion-promoting layer.

If a reinforcing layer is not used, a layer of the binder preparation comprising the silphenylene polymers of the formula (I) is produced by deposition of a layer of binder preparation on a carrier, such as a release film or release plate, for example, with material suitable for the carrier being in principle any material from which the dried or cured binder preparation can later be detached again, such as, for example, polytetrafluoroethylene, polyesters and the like. The detachability and also the film-forming properties on the respective carrier material must be determined individually depending on the binder composition. The statements made regarding the process remain equally valid for this reinforcement-free variant.

From the reinforced or unreinforced composite materials from the first step, and the laminated composite materials from the second step, it is possible to generate multilayer systems, by stacking multiple plies of the composite materials from the first step in alternation, for example, with the faced laminates from the second step, one above another, and then curing the as yet uncured composite materials from the first step in an operation corresponding substantially to the procedure for generating the metal-faced laminates. In order to produce thicker layers, it is also possible here to stack multiple plies of the reinforced or unreinforced composites from the first step one over another in direct order.

As well as for producing metal-faced laminates, the silphenylene polymers of the formula (I) may additionally be used in anticorrosion preparations, more particularly for use for corrosion prevention at high temperature.

Moreover, the silphenylene polymers of the formula (I) and preparations comprising them may also be used for corrosion protection of reinforcing steel in steel-reinforced concrete. Corrosion inhibition effects in steel-reinforced concrete are in that case achieved both when the silphenylene polymers of the formula (I) and preparations comprising them are introduced into the concrete mixture before the mixture is shaped and cured, and when the silphenylene polymers of the formula (I) or preparations comprising them are applied to the surface of the concrete after the concrete has cured.

As well as for the purpose of corrosion prevention on metals, the silphenylene polymers of the formula (I) may also serve for manipulating further properties of preparations comprising the silphenylene polymers of the invention, or of solid bodies or films obtained from preparations comprising the silphenylene polymers of the formula (I), with examples being as follows:
controlling electrical conductivity and electrical resistance
controlling flow properties of a preparation
controlling gloss of a wet or cured film or an object
increasing weathering resistance
increasing chemicals resistance
increasing hue stability
reducing chalking propensity
reducing or increasing static and sliding friction on solid bodies or films obtained from preparations comprising polyorganosiloxanes of the formula (I)
stabilizing or destabilizing foam in the preparation comprising the preparation
improving adhesion of the preparation comprising the polyorganosiloxanes of the formula (I) to substrates
controlling the filler and pigment wetting and dispersing behavior,
controlling the rheological properties of the preparation comprising the silphenylene polymers of the invention,
controlling mechanical properties, such as flexibility, scratch resistance, elasticity, extensibility, bendability, breaking behavior, resilience behavior, hardness, density, tear resistance, compression set, behavior at different temperatures, expansion coefficient, abrasion resistance, and also further properties such as thermal conductivity, combustibility, gas permeability, resistance to water vapor, hot air, chemicals, weathering and radiation, sterilizability, of solid bodies or films obtainable and comprising the silphenylene polymers of the formula (I) or preparations comprising them,
controlling electrical properties, such as, for example, dielectric loss factor, breakdown resistance, dielectric constant, leakage current resistance, arc resistance, surface resistance, specific breakdown resistance,
flexibility, scratch resistance, elasticity, extensibility, bendability, breaking behavior, resilience behavior, hardness, density, tear resistance, compression set, behavior at different temperatures of solid bodies or films obtainable from the preparation comprising the silphenylene polymers of the formula (I).

Examples of applications in which the silphenylene polymers of the formula (I) can be used to manipulate the properties designated above are the production of coating materials and impregnation systems and resultant coatings and coverings on substrates, such as metal, glass, wood, mineral substrate, synthetic and natural fibers for producing textiles, carpets, floor coverings or other wares producible from fibers, leather, plastics such as films, and moldings. With appropriate selection of the preparation components, moreover, the silphenylene polymers of the formula (I) may be used in preparations as an additive for the purpose of defoaming, flow promotion, hydrophobization, hydrophilization, filler and pigment dispersion, filler and pigment wetting, substrate wetting, promotion of surface smoothness, reduction of static and sliding friction on the surface of the cured material obtainable from the additized preparation. The silphenylene polymers of the formula (I) may be incorporated in liquid form or in cured solid form into elastomer compositions. In that case they may be used for reinforcement or for improving other service properties, such as controlling transparency, heat resistance, yellowing propensity or weathering stability. All of the above symbols in the above formulae have their definitions in each case independently of one another. In all formulae, the silicon atom is tetravalent.

### EXAMPLES

The examples which follow serve for further elucidation of the invention. They should be understood as being illustrative, not restrictive.

Unless otherwise indicated, all manipulations are performed at room temperature of 23° C. and under atmospheric pressure (1.013 bar).

Unless otherwise indicated, all data describing product properties are valid at room temperature of 23° C. and under atmospheric pressure (1.013 bar).

The apparatuses are commercially customary laboratory apparatus of the kind offered commercially by numerous apparatus manufacturers.
Ph denotes a phenyl radical ═C₆H₅—
Me denotes a methyl radical ═CH₃—. Me₂, correspondingly, denotes two methyl radicals.
PPE denotes polyphenylene ether.
HCl denotes hydrogen chloride.

In the present text, substances are characterized by reporting of data obtained via instrumental analysis. The underlying measurements are either carried out following publically available standards or ascertained according to specially developed methods. To ensure clarity of the teaching given, the methods used are indicated below.

In all examples, the figures for parts and percentages are based on weight, unless otherwise indicated.

### Viscosity

The viscosities, unless otherwise indicated, are determined by rotational viscometry according to DIN EN ISO 3219. Unless otherwise indicated, all viscosity data are valid at 25° C. and atmospheric pressure of 1013 mbar.

### Refractive Index

The refractive indices are determined in the wavelength range of visible light, unless otherwise indicated at 589 nm at 25° C. and atmospheric pressure of 1013 mbar according to standard DIN 51423.

### Transmission

The transmission is determined by UV VIS spectroscopy. An example of a suitable instrument is the Analytik Jena Specord 200.

The measuring parameters used are as follows: range: 190-1100 nm

Step size: 0.2 nm, integration time: 0.04 s, measuring mode: step operation. The reference measurement (background) is performed first. A quartz plate secured to a sample holder (quartz plate dimensions: HxW around 6×7 cm, thickness around 2.3 mm) is placed into the sample beam path and measured against air.

Sample measurement then follows: a quartz plate secured to the sample holder and carrying the applied sample—layer thickness of applied sample around 1 mm—is placed into the sample beam path and measured against air. Internal calculation relative to the background spectrum yields the transmission spectrum of the sample.

### Molecular Compositions

The molecular compositions are determined using nuclear magnetic resonance spectroscopy (for terminologies see ASTM E 386: High-resolution nuclear magnetic resonance (NMR) spectroscopy: terms and symbols), with measurement of the ¹H nucleus and the ²⁹Si nucleus.

### Description of ¹H-NMR Measurement

Solvent: CDCl3, 99.8% d
Sample concentration: around 50 mg/1 ml of CDCl3 in 5 mm NMR tube
Measurement without addition of TMS, spectral referencing of residual CHCl3 in
CDCl3 at 7.24 ppm
Spectrometer: Bruker Avance I 500 or Bruker Avance HD 500
Probe: 5 mm BBO probe or SMART probe (Bruker)
Measuring parameters:
Pulprog=zg30
TD=64 k
NS=64 or 128 (depending on probe sensitivity)
SW=20.6 ppm
AQ=3.17 s
D1=5 s
SFO1=500.13 MHz
O1=6.175 ppm
Processing parameters:
SI=32 k
WDW=EM
LB=0.3 Hz

Individual adaptations of the measuring parameters may be necessary according to the type of spectrometer used.

### Description of ²⁹Si-NMR measurement:

Solvent: C6D6 99.8% d/CCl4 1:1 v/v with 1 wt % of
Cr(acac)₃ as relaxation reagent
Sample concentration: around 2 g/1.5 ml of solvent in 10 mm NMR tube
Spectrometer: Bruker Avance 300
Probe: 10 mm 1H/13C/15N/29Si glass-free QNP probe (Bruker)
Measuring parameters:
Pulprog=zgig60
TD=64 k
NS=1024 (depending on probe sensitivity)
SW=200 ppm
AQ=2.75 s
D1=4 s
SFO1=300.13 MHz
O1=−50 ppm
Processing parameters:
SI=64 k
WDW=EM
LB=0.3 Hz

Individual adaptations of the measuring parameters may be necessary according to the type of spectrometer used.

### Molecular Weight Distributions

Molecular weight distributions are determined as weight average Mw and as number average Mn, where using the method of gel permeation chromatography (GPC or Size Exclusion Chromatography (SEC)) with a polystyrene standard and a refractive index detector (RI detector). Unless otherwise identified, THF is used as eluent and DIN 55672-1 is employed. The polydispersity is the ratio Mw/Mn.

### Glass Transition Temperatures

The glass transition temperature is determined by differential scanning calorimetry (DSC) according to DIN 53765, perforated crucible, heating rate 10 K/min.

### Determination of Particle Size

The particle sizes were measured by the method of dynamic light scattering (DLS) with determination of the zeta potential.

The auxiliaries and reagents used for the determination were as follows:

Polystyrene cuvettes of 10×10×45 mm, Pasteur pipettes for single use, ultrapure water.

The sample for measurement is homogenized and introduced without bubbles into the measuring cuvette.

The measurement takes place at 25° C. after an equilibration time of 300 s, with high resolution and automatic measuring time adjustment.

The values reported are always based on the D(50) value. D(50) is to be understood as the volume-averaged particle diameter at which 50% of all the measured particles have a volume-averaged diameter smaller than the specified value of D(50).

### Determination of Dielectric Properties: Df, Dk

The dielectric properties are determined according to IPC TM 650 2.5.5.13 using a Keysight/Agilent E8361A network analyzer according to the split-cylinder resonator method at 10 GHz.

### Microscopy Procedure

The micro/nanostructure was characterized respectively by optical microscopy and by transmission electron microscopy.
Optical microscopy:
Sample preparation: 1 drop of sample (neat) on slide; covered with cover glass
Instrument: LEICA DMRXA2 with LEICA DFC420 CCD camera (2592×1944 pixels)
Imaging: transmitted light-interference contrast, various magnification stages
Transmission electron microscopy:
Sample preparation: 1 drop of sample (dilution 1:20, adaptation required if necessary) on coated TEM grid; addition of a contrast agent if required; drying at RT

Instrument: ZEISS LIBRA 120 with Sharp Eye CCD camera (1024×1024 pixels)
Imaging: excitation voltage 120 kV; TEM brightfield; various magnification stages

### Peel Strength Test for Adhesion

The adhesion of the metal layers laminated onto the composite layers with or without reinforcing material was determined according to the IPC-TM 650 method 2.4.8 “Peel Strength of Metallic Clad Laminates” in the “as received” version, i.e., without thermal loading or exposure.

A 35 μm copper foil, mass 285±10 g/m², roughness depth Rz≤8 μm, mean roughness Ra≤0.4 μm was laminated to both sides of a composite layer with a thickness of 100 μm, with curing and laminating taking place for 180 min at 200° C., 2.0 MPa, 30 mmHg column.

### Flammability Testing

The testing was conducted according to the provisions of UL 94-V from Underwriters Laboratories, as a vertical fire test. Prior to testing, the specimens were conditioned as follows: 2 days of storage at 23° C. and 50% relative humidity, followed by 7 days at 70° C. in a hot-air oven. Flame application was made with a Tirill burner flame. The flame application time was 2×10 s in each case. The second flaming time begins as soon as the ignited sample has extinguished. With samples not ignited, the second flaming takes place immediately after the first flaming. The length of the test section was 5″ (127 mm) and the width 0.5″ (12.7 mm). The plates under test had a thickness of 0.4″ (10.2 mm). The plates were secured in vertical position at the upper end in a length of ¼″. 12″ (305 mm) beneath the test plate, a mesh coated with surgical cotton was placed. The burner is adjusted so as to produce a blue flame with a length of ¾″. The flame is directed at the lower edge of the plastic plate from a distance of ⅜″ (9.5 mm). After 10 seconds of exposure, the flame is removed. The flame abatement time of the experimental piece is recorded. As soon as flame development ceases, the burner flame is placed under the experimental piece again for 10 seconds. Following the removal of the flame, the flame abatement time and the glow time of the piece are recorded. The test is carried out on five different experimental pieces.

### Synthesis Example 1: Preparation of a Silphenylene Polymer by the Process of the Invention From Chlorosilanes

A 2 l three-necked flask glass apparatus with bulb condenser and dropping funnel is charged with 48 g of magnesium turnings (2 mol). The apparatus is then evacuated to an internal pressure of 10⁻³ mbar and at the same time the glass walls are subjected to a temperature of 270° C. using a hot-air blower in order to remove residues of water adhering to the magnesium and to the glass wall. The vacuum is then broken with argon until the pressure prevailing in the interior of the apparatus is 1013 mbar. The apparatus is allowed to cool to room temperature at 23° C.

The apparatus is charged with 250 ml of dried 1,4-dioxane which has been purged with nitrogen. A grain of iodine with a mass of around 50 mg is added and heating takes place to an internal temperature of 60° C. 118 g (0.5 mol) of 1,4-dibromobenzene are dissolved under a dry nitrogen atmosphere in 400 ml of dried, nitrogen-purged 1,4-dioxane, and the mixture is transferred into the dropping funnel. The mixture is metered at a uniform rate over the course of 3 h, accompanied by heating to compensate the exothermic warming that occurs, such that the internal temperature does not exceed 65° C. This is followed by stirring at 65° C. for 7 h in order to complete the reaction to form the 1,4-dibromobenzene Grignard reagent. A gray, turbid preparation is obtained.

The reaction mixture is cooled to 2° C. A mixture of 89.8 g of a mixture of 0.14 mol of vinyldimethylchlorosilane and 0.57 mol of dimethyldichlorosilane is introduced into the dropping funnel. This step as well takes place under dry nitrogen as inert gas. The silane mixture is metered in at a uniform rate over the course of 3 h, again with cooling to keep the temperature at below 5° C. At the end of metering, stirring takes place for a further 3 h at 2° C. The reaction mixture is subsequently filtered through a filter plate having a pore size of 1.2 μm. The filtrate is clear and of low viscosity. The 1,4-dioxane is then evaporated off at 120° C. under a reduced pressure of 20 mbar. The product is a slightly reddish yellow solid, which for further working up is then dissolved in toluene to form a 50% strength solution. 200 ml of fully demineralized water are added to the toluenic solution with stirring, the stirrer is switched off, and the preparation is allowed to come to rest, with the aqueous phase and organic phase separating from one another. The aqueous phase is drained off and the washing procedure is repeated three times more in the same way. The organic phase which remains is admixed with 30 g of sodium sulfate, stirred for 5 min, and then isolated by filtration through a 1.2 μm filter plate. The toluene is subsequently distilled off completely at 120° C. and a reduced pressure of 20 mbar, to give an orange- colored solid.
SEC: Mw=1050 g/mol, Mn=713 g/mol, polydispersity PD=1.47.
Silanol and alkoxy groups are not detectable in the ¹H-NMR.
According to ²⁹Si-NMR, the molar composition of the silicon-containing fraction of the preparation is:
(CH₂═CH)Me₂Si(C₆H₄)—: 21.8%
—(C₆H₄)(Me₂)Si(C₆H₄)—: 78.2%

Here, half of each bridging —(C₆H₄)— radical is counted for each Si atom bonded to it. This product is readily soluble in toluene. An 80% strength toluenic solution, consisting of 80% of the reaction product in 20% of toluene, can be prepared easily.

The percent figures are based on the mass. In the use examples, however, a 50% strength toluenic solution is used, since the counter-examples have a lower solubility and in this way the intention is to ensure comparability. The 50% preparation is identified below as 1.1.

The silphenylene polymer prepared here is not accessible according to EP 0913420, since it is not preparable by hydrosilylation.

### Synthesis Example 2: Preparation of a Silphenylene Polymer by the Process of the Invention From Alkoxysilanes

The procedure corresponds to that described in synthesis example 1, with the following differences:

Instead of 1,4-dioxane, the solvent used is THF. Instead of a mixture of the chlorosilanes, 84.6 g of a mixture of 0.14 mol of vinyldimethylmethoxysilane (116 g/mol) and 0.57 mol of dimethyldimethoxysilane (120 g/mol) is used.

In the product obtained, no silanol groups are detectable by ¹H-NMR. According to ¹H-NMR, methoxy groups are present in an amount of around 0.1 weight percent.

By SEC (eluent: toluene), the following molecular weights were determined: Mw=1134 g/mol, Mn=803 g/mol, polydispersity PD=1.41.

According to ²⁹Si-NMR, the molar composition of the silicon-containing fraction of the preparation is:
(CH₂═CH)Me₂Si(C₆H₄)—: 22.1%
—(C₆H₄)(Me₂)Si(C₆H₄)—: 77.9%

Here, half of each bridging −(C₆H₄)— radical is counted for each Si atom bonded to it. This product is readily soluble in toluene. An 80% strength toluenic solution, consisting of 80% of the reaction product 20% of toluene consists is prepared easily. The percent figures are based on the mass. In the use examples, however, a 50% strength toluenic solution is used, since the counter-examples have a lower solubility and in this way the intention is to ensure comparability. The 50% preparation is identified below as 2.1.

The silphenylene polymer prepared here is not accessible according to EP 0913420, since it is not preparable by hydrosilylation.

### Synthesis Example 3: Preparation of a Silphenylene Polymer of the Invention from Alkoxysilanes Using a Multihalogenated Organic Raw Material

The procedure corresponds to that described in synthesis example 1, with the following differences:

Instead of 1,4-dioxane, the solvent used is THF. Instead of a mixture of the chlorosilanes, 67.8 g of a mixture of 0.14 mol of vinyldimethylmethoxysilane (116 g/mol) and 0.43 mol of dimethyldimethoxysilane (120 g/mol) is used. Instead of 1,4-dibromobenzene, 0.25 mol (118 g) of 3,3′,5,5′-tetrabromo-1,1′-biphenyl is used.

In the product obtained, no silanol groups are detectable by ¹H-NMR. According to ¹H-NMR, methoxy groups are present in an amount of <0.1 weight percent.

By SEC (eluent: toluene), the following molecular weights were determined: Mw=1347 g/mol, Mn=941 g/mol, polydispersity PD=1.43.

According to 29Si-NMR, the molar composition of the silicon-containing fraction of the preparation is:
(CH₂=CH)Me₂Si(C₁₂H₈)—: 21.3%
(C₁₂H₈)(Me₂)Si(C₁₂H₈)—: 78.7%

Here, a quarter of each bridging —(C₁₂H₈)— radical is counted for each Si atom bonded to it.

This product is readily soluble in toluene. An 80% strength toluenic solution, consisting of 80% of the reaction product 20% of toluene consists is prepared easily. The percent figures are based on the mass. In the use examples, however, a 50% strength toluenic solution is used, since the counter-examples have a lower solubility and in this way the intention is to ensure comparability. The 50% preparation is identified below as 3.1. The silphenylene polymer prepared here is not accessible according to EP 0913420, since it is not preparable by hydrosilylation.

### Synthesis example 4: Preparation of a silphenylene-silalkylene Copolymer of the Prior Art, According to Example 1 in EP 0913420, as Non-Invention Comparative Example

The 1,4-bis(phenylmethylvinylsilyl)phenylene and 1,4-dis(dimethylsilyl)phenylene starting materials were prepared by Grignard synthesis. A suitable procedure for this is the same as that described in synthesis example 1.

Here, in the case of 1,4-bis(phenylmethylvinylsilyl)phenylene, in the first step a di-Grignard reagent in THF is generated from the 1,4-dibromobenzene and from four times the molar amount of magnesium turnings, based on the amount of 1,4-dibromobenzene used, and in the second step this reagent was reacted with twice the molar amount, based on the dibromobenzene, of phenylmethylvinylmethoxysilane as described in the example. This gives the desired 1,4-bis(phenylmethylvinylsilyl)phenylene, whose identity was confirmed analytically by ¹H and ²⁹Si-NMR spectroscopy. The same procedure was employed for preparing 1,4-bis(dimethylsilyl)phenylene, this time using the corresponding amount of dimethylmethoxysilane rather than the phenylmethylvinylmethoxysilane. Here again, the acquisition of the desired chemical component can be demonstrated by NMR spectroscopy. At this point, a quite substantial difference of this prior art relative to the invention expounded here is already apparent, since the cost and complexity merely for preparing for the experiment according to example 1 of EP 0913420 is already twice as high as the cost and complexity involved in preparing a silphenylene polymer of the invention. The further conduct of the experiment corresponds in all details to the description according to example 1 in EP 0913420. As the outcome, a solid reaction product is obtained which according to SEC has a weight-average molecular weight of Mw=19 900 g/mol. EP 0913420 does not give figures for Mn and PD, and so no comparison is possible here. In the present case, the values obtained were as follows: Mn=3042 g/mol and PD=6.54. In both the ¹H-NMR and the ²⁹Si-NMR, the expected signals for the structural groups are found, and so the product obtained here is without doubt chemically identical to the product according to example 1 in EP 0913420. The product obtained is soluble in xylene and toluene at a concentration of up to 50%. Since, in contrast to the silphenylene polymers of the invention, no higher solubility is achieved, this material is used at the concentration of 50% in toluene for the comparison of properties.

This 50% preparation in toluene is now referred to below as 4.1.

### Synthesis Example 5: Preparation of a silphenylene-polysiloxane Copolymer of the Prior Art, According to U.S. Pat. No. 6,072,016 Example 1, as Non-Invention Comparative Example

For example 1 according to U.S. Pat. No. 6072016, an initial polymer is required, according to Reference Example 1 from U.S. Pat. No. 6,072,016, made from 1,4-bis(phenylmethylvinylsilyl)phenylene and 1,4-bis(dimethylsilyl)phenylene, the same starting materials as already described in synthesis example 4, and vinyltrimethoxysilane additionally. The preparation of 1,4-bis(phenylmethylvinylsilyl)phenylene and 1,4-bis(dimethylsilyl)phenylene has already been described in synthesis example 4. In order to obtain the initial polymer for example 1 according to U.S. Pat. No. 6072016, it was prepared in accordance with the description in Reference Example 1 from U.S. Pat. No. 6,072,016. The relative amounts of 1,4-bis(phenylmethylvinylsilyl)phenylene and 1,4-bis(dimethylsilyl)phenylene here are different from synthesis example 4 and from example 1 according to EP 0913420.

Accordingly, the vinyltrimethoxysilane is anhydrosilylated terminally onto remaining Si—H of the 1,4-bis(dimethylsilyl)phenylene used in excess. In this case as well, the chemical identity of the product obtained can be resolved by NMR and SEC analysis to ensure that the product obtained is the same as that described in Reference Example 1 from U.S. Pat. No. 6,072,016. For the product in the experiment reproduced here, the weight-average molecular weight determined by SEC is Mw=9675 g/mol. U.S. Pat. No. 6,072,016 gives no figures for the number-average molecular weight Mn and the polydispersity index PD. In the present case, they were found to be Mn=6365 g/mol and PD=1.52.

In order additionally to remain exactly within the prior art of U.S. Pat. No. 6,072,016, the bistrimethoxysilyl-terminated silphenylene obtained was cured in accordance with the procedure described in example 1 of U.S. Pat. No. 6,072,016, meaning that the curing was carried out using methyltri(methylethylketoxime)silane in toluene. For this purpose, a 50% strength toluenic solution of the bistrimethoxysilyl-terminated silphenylene according to reference example 1 from U.S. Pat. No. 6,072,016 was prepared as described in example 1 of U.S. Pat. No. 6,072,016. This 50% strength toluenic solution, composed of toluene and the bistrimethoxysilyl-terminated silphenylene according to reference example 1 of U.S. Pat. No. 6,072,016, is referred to below as 5.1.

### Use Example 1: Use of the silphenylene Polymers 1.1, 2.1 and 3.1 of the Invention and of the Non-Invention Counter-Examples 4.1 and 5.1 for Producing Copper-Faced Laminates

The silphenylene polymers 1.1, 2.1 and 3.1 of the invention and the non-invention silphenylene-silalkylene copolymer 4.1, and the likewise non-invention alkoxysilyl-terminated silphenylene-silalkylene copolymer 5.1, prepared according to synthesis examples 1 to 5, were used as binders for producing copper-faced laminates having a glass fiber-reinforced composite layer. Materials used were as follows:

Copper foil: 35 μm thick copper foil (285±10 g/m²) from Jiangtong-yates Copper Foil Co Ltd, having a roughness depth of Rz≤8 μm and a mean roughness depth of Ra≤0.4 μm, purity ≥99.8%.

Glass fibers: E-glass fiber type 1080 E produced by Changzhou Xingao Insulation Materials Co. Ltd. Thickness 0.055±0.012 mm, 47.5±2.5 g/m².

To ensure comparability of the binders, all of the binders in this example were used as a 50% strength solution in toluene.

To initiate the curing, the vinyl-functional silphenylene polymers 1.1, 2.1 and 3.1 of the invention and the non-invention silphenylene-silalkylene copolymer 4.1 were each admixed with 1 weight percent of dicumyl peroxide, based on the amount of silphenylene polymer 1.1, 2.1 and 3.1 or silphenylene silalkylene copolymer 4.1 employed, the peroxide being distributed uniformly in the resin matrix by stirring. 5.1 was cured by addition of methyltri(methylethylketoxime)silane in an amount as indicated in example 1 according to U.S. Pat. No. 6,072,016.

Laminates were produced by subjecting glass fiber layers measuring 30×30 cm to ply-by-ply, bubble-free impregnation with the respective organopolysiloxane, where appropriate as a toluenic solution, with the aid of an air removal roller. In this procedure, the glass fiber layers were mounted on a planar, dimensionally stable stainless steel support, to which one ply of copper foil was applied before the first ply of glass fibers was placed on. In total, 3 plies of glass fiber fabric in each case were successively impregnated. To remove the solvent, where appropriate, the impregnated fabrics were dried to constant weight in a vacuum drying oven at 10 mbar and 60° C. Thereafter a second layer of copper foil was applied atop the impregnated glass fiber layer, and a further dimensionally stable stainless steel plate was placed on. The laminate was baked in a heatable press with a pressure of 2 MPa for 120 min at 200° C. and a reduced pressure of 30 mbar. This produces copper-faced laminates having a total thickness of 260±20 μm.

The dielectric properties were determined according to IPC TM 650 2.5.5.13 with a Keysight/Agilent E8361A network analyzer according to the split-cylinder resonator method at 10 GHz. Values obtained were as follows:

| Test substance | Dₖ | D_{f} |
|---|---|---|
| 1.1 (invention) | 3.08 | 0.0019 |
| 2.1 (invention) | 3.10 | 0.0020 |
| 3.1 (invention) | 3.10 | 0.0018 |
| 4.1 (non-invention) | 3.37 | 0.0033 |
| 5.1 (non-invention) | 3.73 | 0.0045 |

The D_{f} and Dₖ values of the copper-faced laminates made from the silphenylene polymers of the invention and from the silphenylene-silalkylene copolymer are much lower than the D_{f} and Dₖ values cured with the ketoxime-cured silphenylene-silalkylene copolymer according to U.S. Pat. No. 6,072,016, which because of the ketoximesilane used possesses a significant organopolysiloxane fraction and hence a higher polarity. Given that radiofrequency applications require extremely low dielectric loss factors and relative permittivities, this is undesirable, and the silphenylene polymers of the invention represent an improvement over this prior art in terms of the dielectric properties. The non-invention silphenylene-silalkylene polymers are more similar to the silphenylene polymers of the invention in terms of the dielectric properties, but fail to match them. While they are comparable with the silphenylene polymers of the invention in terms of the degree of avoidance of polar siloxane bonds, it is nevertheless the case that in the non-invention silphenylene-silalkylene copolymers, as a result of the selected mode of preparation by hydrosilylation, residues of platinum remain in the product and adversely affect the dielectric properties and cause an increase in the dielectric loss factor. Accordingly, while the chemical composition of the silphenylene-silalkylene copolymers on its own is suitable in principle for achieving the dielectric properties according to the invention, it can only be utilized if the platinum residues are successfully removed. This causes additional cost and complexity and therefore reduces the profitability of this technology relative to the silphenylene polymers that are the subject of the invention. Moreover, in the fourth synthesis example, it has already been indicated that the starting materials for the hydrosilylation can be obtained only by two upstream Grignard syntheses, thereby multiplying the overall cost and complexity relative to the technology of the invention and making it uneconomic and no longer commercially feasible.

### Use Example 2: Use of the silphenylene Polymers 1.1, 2.1 and 3.1 of the Invention and of the Non-Invention Counter-Examples 4.1 and 5.1 for Producing Copper-Faced Laminates Via Prepregs

The silphenylene polymers 1.1, 2.1 and 3.1 of the invention and the non-invention silphenylene-silalkylene copolymer 4.1, and the likewise non-invention alkoxysilyl-terminated silphenylene-silalkylene copolymer 5.1, prepared according to synthesis examples 1 to 5, were used as binders for producing copper-faced laminates having a glass fiber-reinforced composite layer.

Instead of constructing the laminate directly without an intermediate prepreg stage, as in use example 1, this time prepregs were produced, by impregnating the glass fiber plies, as individual plies in each case on a polytetrafluoroethylene film, with the resin preparation and then drying them to constant weight in a vacuum drying oven. Sets of three plies of impregnated glass fiber fabric produced in this way were subsequently deposited one over another onto a copper foil, and the stack was finished off with a ply of copper foil. This multilayer construction was pressed and cured, in analogy to use example 1, between two dimensionally stable stainless steel plates in a vacuum press under the conditions as indicated in example 1.

The laminates obtained had thicknesses of 290±20 μm.

The dielectric properties measured on the laminates obtained were as follows:

| Test substance | Dₖ | D_{f} |
|---|---|---|
| 1.1 (invention) | 3.10 | 0.0020 |
| 2.1 (invention) | 3.09 | 0.0019 |
| 3.1 (invention) | 3.11 | 0.0019 |
| 4.1 (non-invention) | 3.40 | 0.0035 |
| 5.1 (non-invention) | 3.87 | 0.0048 |

The D_{f} and Dₖ values of the copper-faced laminates made from the silphenylene polymers of the invention and from the silphenylene-silalkylene copolymer are much lower than the D_{f} and Dₖ values cured with the ketoxime-cured silphenylene- silalkylene copolymer according to U.S. Pat. No. 6,072,016, which because of the ketoximesilane used possesses a significant organopolysiloxane fraction and hence a higher polarity. Given that radiofrequency applications require extremely low dielectric loss factors and relative permittivities, this is undesirable, and the silphenylene polymers of the invention represent an improvement over this prior art in terms of the dielectric properties. The non-invention silphenylene-silalkylene polymers are more similar to the silphenylene polymers of the invention in terms of the dielectric properties, but fail to match them. While they are comparable with the silphenylene polymers of the invention in terms of the degree of avoidance of polar siloxane bonds, it is nevertheless the case that in the non-invention silphenylene-silalkylene copolymers, as a result of the selected mode of preparation by hydrosilylation, residues of platinum remain in the product and adversely affect the dielectric properties and cause an increase in the dielectric loss factor. Accordingly, while the chemical composition of the silphenylene-silalkylene copolymers on its own is suitable in principle for achieving the dielectric properties according to the invention, it can only be utilized if the platinum residues are successfully removed. This causes additional cost and complexity and therefore reduces the profitability of this technology relative to the silphenylene polymers that are the subject of the invention. Moreover, in the fourth synthesis example, it has already been indicated that the starting materials for the hydrosilylation can be obtained only by two upstream Grignard syntheses, thereby multiplying the overall cost and complexity relative to the technology of the invention and making it uneconomic and no longer commercially feasible.

### Use Example 3: Use of the silphenylene Polymers 1.1, 2.1 and 3.1 of the Invention and of the Non-Invention Counter-Examples 4.1 and 5.1 in a Mixture With Organic Polymers for Producing Copper-Faced Laminates

The procedure corresponds substantially to that described in use example 2, but this time organic polymers were used in a mixture with the silphenylene polymers 1.1, 2.1 and 3.1 of the invention and the non-invention silphenylene-silalkylene copolymer 4.1, and the likewise non-invention alkoxysilyl-terminated silphenylene-silalkylene copolymer 5.1, as binders for producing copper-faced laminates having a glass fiber-reinforced composite layer.

The final solvent-free mixtures always contained 30 weight percent of the components 1.1, 2.1, 3.1, 4.1 and 5.1, respectively, in each case mixed with 70 weight percent of organic polymer. Organic polymers were triallyl isocyanurate, NORYL SA 9000, an alpha, omega-methacrylate-terminated polyphenylene ether obtained from SABIC, Mn=2500 g/mol, Tg=160° C., and B 3000 from Nippon Soda, a liquid polybutadiene with Mn=3200, viscosity at 45° C.=210 poise with more than 85% 1,2-vinyl structure in the polymer chain.

The polymers were always used in the same proportion. They were dissolved or dispersed in xylene, with 30 parts by weight of SA 9000, 25 parts by weight of B 3000 and 15 parts by weight of triallyl isocyanurate being dispersed with 100 parts by weight of xylene.

The resulting preparation was mixed with the toluenic solutions of components 1.1, 2.1, 3.1, 4.1 and 5.1, respectively, in accordance with use example 2, such that in each case the specified proportion of 30% of 1.1, 2.1, 3.1, 4.1 or 5.1 and 70% of organic components was present in the solution obtained. These solutions were then used, as described in use example 2, to produce copper-faced laminates via prepregs.
The laminates obtained had thicknesses of 290±20 μm.
The dielectric properties measured on the laminates obtained were as follows:

| Test substance | Dₖ | D_{f} |
|---|---|---|
| 1.1 (invention) | 3.01 | 0.0019 |
| 2.1 (invention) | 3.00 | 0.0018 |
| 3.1 (invention) | 3.00 | 0.0018 |
| 4.1 (non-invention) | 3.39 | 0.0034 |
| 5.1 (non-invention) | 3.67 | 0.0041 |

The Dₖ and D_{f} values achieved for the copper-faced laminates using the silphenylene polymers 1.1, 2.1 and 3.1 of the invention are much lower than the D_{f} and Dₖ values achieved with the non-invention silphenylene-silalkylene copolymer 4.1 and with the likewise non-invention alkoxysilyl-terminated silphenylene-silalkylene copolymer 5.1. Given that radiofrequency applications require extremely low dielectric loss factors and relative permittivities, the effect according to the invention is clearly apparent.

### Use Example 4

Implementation of a fire test according to UL 94 V:

The test was conducted as a vertical fire test in accordance with the provisions of UL 94-V from Underwriters Laboratories. The test specimens composed of the silphenylene polymers 1.1, 2.1 and 3.1 of the invention and the non-invention silphenylene-silalkylene copolymer 4.1 were obtained from the toluenic solutions to which in each case 2% of dicumyl peroxide was admixed for curing, with percentages being weight percent and being based on the amount of dissolved product as 100%. The overall 50% strength solution thus contains 1 weight percent of dicumyl peroxide. The solutions were each poured out to a suitable size, and the solvent was then evaporated off in a forced-air oven in stages, initially for 4 hours at 80° C. and subsequently at 120° C. for 2 hours, before the evaporation residues obtained were cured at 200° C. for 2 hours. The procedure for curing the non-invention alkoxysilyl- terminated silphenylene-silalkylene copolymer 5.1 involved the addition of the ketoximesilane, already described above, as described in example 1 in U.S. Pat. No. 6,072,016. The procedure for generating the sample specimen corresponds otherwise to the procedure as described for the specimens of 1.1, 2.1, 3.1 and 4.1.

The specimens obtained were conditioned prior to testing, under the following conditions: 2 days of storage at 23° C. and 50% relative humidity, followed by 7 days at 70° C. in a hot air oven. The flame was applied using a Tirill burner flame. The flaming time was in each case 2×10 s. The second flaming time begins as soon as the ignited sample has extinguished. In the case of samples not ignited, the second flaming takes place immediately after the first flaming. The length of the test piece was 5″ (127 mm) and the width was 0.5″ (12.7 mm). The plates under test were 0.4″ (10.2 mm) thick. The plates were secured at the upper end in a length of ¼″ in a vertical position. 12″ (305 mm) below the test plate, a grid coated with surgical cotton was placed. The burner is adjusted so as to produce a blue flame with a length of ¾″. The flame is directed at the lower edge of the plastic plate from a distance of ⅜″ (9.5 mm). After 10 seconds of exposure, the flame is removed. The flame abatement time of the experimental piece is recorded. As soon as flame formation ceases, the flame of the burner is again placed for 10 seconds below the experimental piece. Following the removal of the flame, the flame abatement time and the glow time of the piece are recorded. The test is carried out on five different experimental pieces.

Results obtained were as follows:

| Test criterion | 1.1 | 2.1 | 3.1 | 4.1* | 5.1* |
|---|---|---|---|---|---|
| Burning time after flaming | 3 s | 5 s | 4 s | 25 s | 16 s |
| After-burning and afterglow of | 16 s | 11 s | 14 s | 53 s | 32 s |
| the sample after second | | | | | |
| flaming | | | | | |
| Burning dropping (ignition of | no | no | no | yes | no |
| the cotton) | | | | | |
| Sample fully consumed by | no | no | no | no | no |
| burning | | | | | |
| Flammability class | V-0 | V-0 | V-0 | V-2 | V-1 |

*non-invention

Flammability class V-0 is the highest flammability class under UL94-V. V-0 is the requirement for the target application of copper-faced laminates for radiofrequency applications. Only the silphenylene polymers of the invention meet this requirement. All in all, both the synthesis example and the use examples demonstrate that the desired effect of the invention is achieved and that the existing prior art is improved in the required way by means of the present invention.

1-15. (canceled)

16. Silphenylene polymers of the formula (I), comprising:
RₐR¹_{b}Si[Y[(SiR²_{c}R³_{d})ₑ]_{f}]_{g}YSiRₐR¹_{b} (I).
wherein R may be identical or different radicals and are a hydrogen radical or an olefinically or acetylenically unsaturated, aliphatic or cycloaliphatic hydrocarbon radical;
wherein R² independently of one another are identical or different radicals, where R² may be a hydrogen radical or a saturated or olefinically or acetylenically unsaturated, Si—C-bonded C₁-C₁₈ hydrocarbon radical which may be substituted by heteroatoms, where the two or more oxygen atoms in the same radical R² are always separated from one another by hydrocarbon units and where oxygen atoms and silicon atoms are not joined to one another to form Si—O units if both kinds of heteroatom are present simultaneously in one radical R², but instead are always separated from one another by hydrocarbon units, whereas two or more Si atoms in the same radical R² may be joined to one another by direct Si—Si bonds and the Si atoms are always tetravalent and the remaining valences of the Si atoms are saturated by further Si—C-bonded substituents, it being possible for these to be olefinically or acetylenically unsaturated;
wherein R² may also comprise olefinically or acetylenically unsaturated functional groups, which may likewise contain heteroatoms, where R² may also be a hydroxyl radical or a monovalent aliphatic, cycloaliphatic or aromatic, Si—C-bonded, organic hydrocarbon radical which is bonded to the silicon atom through an oxygen atom, is unsubstituted or substituted by heteroatoms and has 1 to 18 carbon atoms;
wherein R¹ and R³ independently of one another may be identical or different radicals and are either a hydrocarbon radical or a monovalent aliphatic, cycloaliphatic or aromatic, Si—C-bonded, organic hydrocarbon radical which is unsubstituted or substituted by heteroatoms and has 1 to 18 carbon atoms, and which may also be an unsaturated hydrocarbon radical, where R¹ and R³ may also be a hydroxyl radical or a monovalent aliphatic, cycloaliphatic or aromatic, Si—C-bonded, organic hydrocarbon radical which is bonded to the silicon atom through an oxygen atom, is unsubstituted or substituted by heteroatoms and has 1 to 18 carbon atoms;
wherein Y is a chemical bond or a di- to dodecavalent aromatic, alkylaromatic or cycloalkylaromatic or a di- to dodecavalent aliphatic or cycloaliphatic radical having 1 to 48 carbon atoms and a main chain of which is free from heteroatoms, where the radical Y, if it is not a chemical bond, is always bonded by Si—C linkage to the silicon atoms that it bridges;
wherein
a is a number with a value of 1 or 2,
b is a number with a value of 1 or 2, where the sum a+b=3,
c is a number with a value of 0, 1 or 2,
d is a number with a value of 0, 1 or 2, where the sum c+d=2,
e is a number from 1 to 12,
f is a number with a value of 1 to 12, and
g is a number with a value of 3 to 250;
wherein at least one olefinically or acetylenically unsaturated radical R, R¹, R² or R³ must be present per silphenylene polymer of the formula (I);
wherein the sum of all organic radicals bonded to Si atoms through an oxygen atom, based on the sum of all Si-bonded radicals R, R¹, R² and R³ as 100 mol %, must not be more than 10 mol %; and
wherein based on all bridging radicals Y as 100 mol %, at least 55 mol % of radicals Y are a di- to dodecavalent aromatic, alkylaromatic and cycloalkylaromatic radical.

17. The polymers of claim 16, wherein the heteroatoms in R² are selected from oxygen atoms and silicon atoms.

18. The polymers of claim 16, wherein the olefinically or acetylenically unsaturated radicals R, R¹, R² or R³ are selected from alkenyl radicals, acryloyloxy and methacryloyloxy radicals of acrylic acid or methacrylic acid, and acrylic esters or methacrylic esters of unbranched or branched alcohols having 1 to 15 carbon atoms.

19. The polymers of claim 16, wherein Y is a bridging aromatic unit having 1 to 24 carbon atoms between two to twelve carbosilyl units.

20. The polymers of claim 16, wherein the bridging aromatic radicals Y are of a formula (IVa), (IVb) and (IVc) 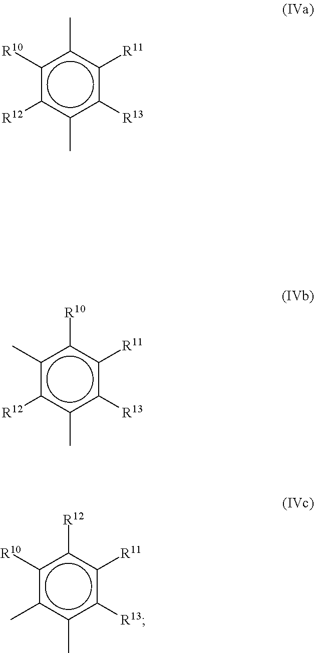
where the radicals R¹⁰, R¹¹, R¹² and R¹³ may be a hydrogen radical or a substituted or unsubstituted hydrocarbon radical or a group of the formula OR¹⁴ where R¹⁴ is a hydrocarbon radical, and where adjacent radicals in the formula (IVa), (IVb) and (IVc) may be coupled to one another to form cyclic radicals, to produce fused ring systems.

21. The polymers of claim 16, wherein the sum of all organic radicals bonded to Si atoms by an oxygen atom, based on the sum of all Si-bonded radicals R, R¹, R² and R³ as 100 mol %, is not more than 1 mol %.

22. The polymers of claim 16, wherein the noncrosslinked state are liquid and at 25° C. possess viscosities of 20 to 8 000 000 mPas, determined by rotational viscometry according to DIN EN ISO 3219 or are solid and possess glass transition temperatures in the range from 25° C. to 250° C., determined by differential scanning calorimetry (DSC) according to DIN 53765, perforated crucible, heating rate 10 K/min.

23. The polymers of claim 16, wherein g is a number with a value of at least 5.

24. The polymers of claim 16, wherein the silphenylene polymers are used in the production of coating materials and impregnation systems and resultant coatings and coverings on substrates, as binders or as additives in preparations.

25. The polymers of claim 16, wherein the silphenylene polymers are used for producing metal-faced laminates.

26. The polymers of claim 25, wherein a metal of the metal-faced laminates is selected from copper, stainless steel, gold, aluminum, silver, zinc, tin, lead and transition metals.

27. A process for preparing silphenylene polymers of the formula (I), comprising:
providing silphenylene polymers of the formula (I)
RₐR¹_{b}Si[Y[(SiR²_{c}R³_{d})ₑ]_{f}]_{g}YSiRₐR¹_{b} (I).
wherein
R may be identical or different radicals and are a hydrogen radical or an olefinically or acetylenically unsaturated, aliphatic or cycloaliphatic hydrocarbon radical,
R² independently of one another are identical or different radicals, where R² may be a hydrogen radical or a saturated or olefinically or acetylenically unsaturated, Si—C-bonded C₁-C₁₈ hydrocarbon radical which may be substituted by heteroatoms, where the two or more oxygen atoms in the same radical R² are always separated from one another by hydrocarbon units and where oxygen atoms and silicon atoms are not joined to one another to form Si—O units if both kinds of heteroatom are present simultaneously in one radical R²,but instead are always separated from one another by hydrocarbon units, whereas two or more Si atoms in the same radical R² may be joined to one another by direct Si—Si bonds and the Si atoms are always tetravalent and the remaining valences of the Si atoms are saturated by further Si—C-bonded substituents, it being possible for these to be olefinically or acetylenically unsaturated,
R² may also comprise olefinically or acetylenically unsaturated functional groups, which may likewise contain heteroatoms, where R² may also be a hydroxyl radical or a monovalent aliphatic, cycloaliphatic or aromatic, Si—C-bonded, organic hydrocarbon radical which is bonded to the silicon atom through an oxygen atom, is unsubstituted or substituted by heteroatoms and has 1 to 18 carbon atoms,
R¹ and R³ independently of one another may be identical or different radicals and are either a hydrocarbon radical or a monovalent aliphatic, cycloaliphatic or aromatic, Si—C-bonded, organic hydrocarbon radical which is unsubstituted or substituted by heteroatoms and has 1 to 18 carbon atoms, and which may also be an unsaturated hydrocarbon radical, where R¹ and R³ may also be a hydroxyl radical or a monovalent aliphatic, cycloaliphatic or aromatic, Si—C-bonded, organic hydrocarbon radical which is bonded to the silicon atom through an oxygen atom, is unsubstituted or substituted by heteroatoms and has 1 to 18 carbon atoms and
Y is a chemical bond or a di- to dodecavalent aromatic, alkylaromatic or cycloalkylaromatic or a di- to dodecavalent aliphatic or cycloaliphatic radical having 1 to 48 carbon atoms and a main chain of which is free from heteroatoms, where the radical Y, if it is not a chemical bond, is always bonded by Si—C linkage to the silicon atoms that it bridges,
wherein
a is a number with a value of 1 or 2,
b is a number with a value of 1 or 2, where the sum a+b=3,
c is a number with a value of 0, 1 or 2,
d is a number with a value of 0, 1 or 2, where the sum c+d=2,
e is a number from 1 to 12,
f is a number with a value of 1 to 12 and
g is a number with a value of 3 to 250,
wherein at least one olefinically or acetylenically unsaturated radical R, R¹, R² or R³ must be present per silphenylene polymer of the formula (I), wherein the sum of all organic radicals bonded to Si atoms through an oxygen atom, based on the sum of all Si-bonded radicals R, R¹, R² and R³ as 100 mol %, must not be more than 10 mol %, and wherein based on all bridging radicals Y as 100 mol %, at least 55 mol % of radicals Y are a di- to dodecavalent aromatic, alkylaromatic and cycloalkylaromatic radical;
providing compounds of the formula (VIII)
[Hal]ₒ-Y (VIII),
wherein
Hal is a Cl, Br or iodine atom,
o is a number from 2 to 12, and
Y is a chemical bond or a di- to dodecavalent aromatic, alkylaromatic or cycloalkylaromatic or a di- to dodecavalent aliphatic or cycloaliphatic radical having 1 to 48 carbon atoms and a main chain of which is free from heteroatoms, where the radical Y, if it is not a chemical bond, is always bonded by Si—C linkage to the silicon atoms that it bridges;
reacting with magnesium and with silicon-containing compounds which are selected from compounds of the formulae (IV), (V) and (VI)
R¹⁵ₕR¹⁶ᵢSi (IV),
R¹⁵ⱼR¹⁶ₖSi[SiRₗ¹⁷Rₘ¹⁸]ₙSiRⱼ¹⁵Rₖ¹⁶ (V),
R¹⁵ⱼR¹⁶ₖSi[SiRₗ¹⁷Rₘ¹⁸]ₙ—X¹—[SiRₗ¹⁷Rₘ¹⁸]ₙSiR¹⁵ⱼR¹⁶ₖ (VI),
wherein
R¹⁵ is a halogen atom or a C1-C3 alkoxy group,
R¹⁶, R¹⁷ and R¹⁸ independently of one another are radicals of the group of the radicals R, R¹, R² or R³, but not a radical of the formula (II), and R¹⁸ may additionally be a halogen radical or a C1-C3 alkoxy radical, which contain no functional groups comprising carbonyl or carboxyl groups, hydroxyl groups, doubly bonded nitrogen atoms, primary, secondary or tertiary amine groups or thiol groups,
X¹ is a chemical bond or a divalent bridging aliphatic, cycloalkylaliphatic, cycloalkylaromatic or an alkylaromatic hydrocarbon radical which contains no functional groups comprising carbonyl or carboxyl groups, hydroxyl groups, doubly bonded nitrogen atoms, primary, secondary or tertiary amine groups or thiol groups and produced by hydrosilylation of a hydrosilylatable, olefinically or acetylenically unsaturated precursor Z of the formula R¹⁹—X²—R¹⁹ in which R¹⁹ is an olefinically or acetylenically unsaturated, hydrosilylatable C2-C8 radical and X² is the radical X¹ shortened on either side by the C2-C8,
h is an integer with a value of 1, 2, 3 or 4,
i is an integer with a value of 0, 1, 2 or 3 and the sum h+i=4,
j is a number with a value of 0, 1, 2 or 3, where j possesses a value of 1 at least at one terminal Si atom of the di-, oligo- or polysilane of the formula (V), so that there is always at least one radical R¹⁵ per molecule of the formula (V),
k is an integer with a value of 0, 1, 2 or 3,
wherein k+j=3,
wherein 1 and m are each a number with a value of 0, 1 or 2, where 1+m=2,
n is a number with a value of 0 to 50, and
compounds of the formula (VIII)
[Hal]ₒ-Y (VIII),
wherein
Hal is a Cl, Br or iodine atom,
o is a number from 2 to 12, and
Y is a chemical bond or a di- to dodecavalent aromatic, alkylaromatic or cycloalkylaromatic or a di- to dodecavalent aliphatic or cycloaliphatic radical having 1 to 48 carbon atoms and a main chain of which is free from heteroatoms, where the radical Y, if it is not a chemical bond, is always bonded by Si—C linkage to the silicon atoms that it bridges.

28. The process of claim 27, wherein the compound of the formula (VIII) is selected from 1,4-dibromobenzene, 1,4-dicholorobenzene, 1,2-dichloroethane and 1,2-dibromoethane.

29. The process of claim 27, wherein the process is carried out in ether.

30. The process of claim 27, wherein the process is performed in stages, by first reacting the component of the formula (VIII) with magnesium and in the second step adding the respectively required selection of components (IV), (V), (VI) and (VII).
